(19) United States
(12) Patent Application Publication
(10) Pub. No.: US 2006/0246232 A1
(43) Pub. Date: Nov. 2, 2006

(54) Optical film, polarizing plate and in-plane switching mode liquid crystal display

(75) Inventors: Nobuo Kubo, Tokyo (JP); Masataka Takimoto, Tokyo (JP); Shinichiro Suzuki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/410,148

(22) Filed: Apr. 25, 2006

(30) Foreign Application Priority Data
Apr. 28, 2005 (JP) JP2005-131513
May 12, 2005 (JP) JP2005-139591

(51) Int. Cl. C09K 19/00

(52) U.S. Cl. 428/1.31

(57) ABSTRACT

An optical film comprising a resin and birefringent needle-shaped particles, the resin being added with the birefringent needle-shaped particles and being stretched to form the optical film (hereafter designated as Optical Film A), wherein (i) the resin exhibits a positive birefringence along a stretching direction when stretched; (ii) the birefringent needle-shaped particle exhibits a negative birefringence along the stretching direction of the optical film; and (iii) the optical film satisfies the following relationships: ny(a)<nz(a)<nz(a), 105 nm≦Ro(a)≦350 nm, 0.2<Nz<0.7, wherein Ro(a) and Nz are defined as follows: Equation (i) Ro(a)=(nx(a)−ny(a))×d, Equation (ii) Nz=(nx(a)−nz(a))/(nx(a)−ny(a)).

This application is based on Japanese Patent Application No. 2005-131513 filed on Apr. 28, 2005, and No. 2005-139591 filed on May 12, 2005 in Japanese Patent Office, the entire content of which is hereby incorporated by reference.

### TECHNICAL FIELD

The present invention relates to an optical film, polarizing plate and an in-plane switching mode liquid crystal display, and in detail relates to an optical film, a polarizing plate and an in-plane switching mode liquid crystal display in which two polarizing plates employed for the liquid crystal display are different from each other in the optical characteristics whereby the viewing angle property is improved.

### BACKGROUND OF THE PRESENT INVENTION

Hitherto, as a display using a liquid crystal material, widely applied have been a liquid crystal display in which nematic liquid crystals are twistedly oriented and an electric field is applied vertically to the substrate. In this display, two-polarizing palates are generally provided on both sides of the liquid crystal layer so that the polarization axes of the polarizing plates are placed orthogonally to each other, and a black image is displayed when the electric field is applied since the liquid crystals are vertically oriented. However, when light obliquely passes through the liquid crystal layer, while liquid crystals are vertically oriented, the polarization direction of the light is rotated due to the birefringence of the liquid crystals. Consequently, only an insufficient black image is obtained when the display is obliquely viewed whereby the image contrast is lowered. As a result, the viewing angle capable of viewing satisfactory image is narrowed.

In order to overcome the above problem, recently proposed is a liquid crystal display using an electric filed parallel to the substrate, namely, an in-plane switching mode liquid crystal display, hereinafter also referred to as an IPS mode liquid crystal display. In the IPS mode liquid crystal display, the liquid crystals rotate in a plane parallel to the surface of the substrate. Accordingly, it has been known that the difference between the degree of birefringence while an electric field is applied and an electric field is not applied is smaller, when light obliquely passes through the liquid crystal layer, resulting in widening the viewing angle.

An optical compensation material having birefringent property is provided between the liquid crystal layer and the polarizing plate as a means for improving the viewing angle and the tone of images of the IPS mode liquid crystal display. Patent Document 1, for example, discloses an electro-optical switching element in which a birefringent optical compensation means is provided between the substrate and the polarizing plate in IPS mode liquid crystal display. Patent Document 2 discloses that, in order to solve the problem in that a white image or a middle tone image is colored to yellow or blue in IPS mode when the image is viewed in an oblique direction, utilized is a birefringent medium provided between the substrate and the polarizing plate so that the angle between the polarization axis of the polarizing plate and the slow axis direction of the birefringent medium is 20 to 60°, and preferably 30 to 50°.

However, the IPS mode has a drawback in principle. In the IPS mode, liquid crystals homogeneously oriented in the horizontal direction and two of the polarizing plate which are positioned so that the transmission axes of them orthogonally cross to each other in the up/down direction and the left/right direction to the front face of the display. Accordingly, sufficient contrast can be obtained when the image is obliquely observed in the up/down direction and the left/right direction because the relative position of the transmission axes of the two polarizing plates are seen in the state of being orthogonal and the birefringence in the homogeneously oriented liquid crystal layer is smaller than that in the twisted mode liquid crystal layer. Contrary to that, when the image is obliquely observed in the direction of 45° to the up/down direction or the left/right direction, the transmission axes of the two polarizing plates are in a relative position so that the angle formed by them is seen to come off from 90°. Consequently, the transmitted light is doubly refracted and leakage of light occurs whereby only insufficient-black image is obtained and the contrast is lowered. Moreover, the reverse in luminance in the black to middle tone region may also occur due to the lowering in the contrast. Such the lowering of the contrast in the direction of 45° has been the drawback of the IPS mode, while it exhibits an excellent viewing characteristics. Although displays using various compensation films have been proposed, problems have been a complicated structure and a producing efficiency of them, and improvements have been desired. For example, Japanese Patent Publication Open to Public Inspection (hereafter referred to as JP-A) No. 2002-207123 discloses a method for producing a retardation film by heat shrinking treatment to a heat shrinkable film, and a condition of n_{z}>nₓ>n_{y} can be attained by such the method. JP-A No. 2001-174632 discloses a producing method of a retardation film containing the region of n_{z}>nₓ>n_{y}, and the producing process including a heat shrinking treatment.

However, the optical films produced by these method have problems in that the uniformity in retardation and flatness of the film have not been fully sufficient, whereby the uniformity in quality of the display employing thus prepared polarizing plate have not been fully enough.

(Patent Document 1) JP-A No. 5-505247

(Patent Document 2) JP-A No. 9-80424

### SUMMARY OF THE PRESENT INVENTION

An object of the present invention is to provide an optical film, a polarizing plate and an IPS mode liquid crystal display, in which two polarizing plates exhibiting different optical properties are employed in the IPS mode liquid crystal display and the viewing angle property of the IPS mode liquid crystal display is further improved.

One of the aspects of the present invention is an optical film comprising a resin and birefringent needle-shaped particles, the resin being added with the birefringent needle-shaped particles and being stretched to form the optical film (hereafter designated as Optical Film A), wherein (i) the resin exhibits a positive birefringence along a stretching direction when stretched; (ii) the birefringent needle-shaped particle exhibits a negative birefringence along the stretching direction of the optical film; and

(iii) the optical film satisfies the following relationships:
ny(a)<nz(a)<nx(a)
105 nm≦Ro(a)≦350 nm
0.2<Nz<0.7
wherein Ro(a) and Nz are defined as follows:
Ro(a)=(nx(a)−ny(a))×d Equation (i)
Nz=(nx(a)−nz(a))/(nx(a)−ny(a)) Equation (ii)
wherein y represents the stretching direction of the resin film, ny(a) represents an in-plane refractive index of the optical film along the stretching direction, nx(a) represents an in-plane refractive index of the optical film along a direction orthogonal to the stretching direction, nz(a) represents an refractive index of the optical film along a thickness direction of the optical film, and d represents a thickness (nm) of the optical film.

### BRIEF DESCRIPTION OF THE DRAWINGS

FIG. 1 is a drawing describing the stretching angle in the stretching process.

FIG. 2 shows a schematic drawing showing an example of the tenter process employed in the present invention.

FIG. 3 is a schematic drawing showing the structure of IPS mode liquid crystal display preferable for the present invention.

FIG. 4 is a schematic drawing showing the optical film, the polarizing element and the direction of the absorbing axis/transmission axis of the IPS mode liquid crystal display preferable for the present invention.

FIG. 5 is a schematic drawing showing another combination of the optical film, the polarizing element and the direction of the absorbing axis/transmission axis of the IPS mode liquid crystal display preferable for the present invention.

### DESCRIPTION OF THE PREFERRED EMBODIMENTS

The above object of the present invention is attained by the-following structures.
(1) An optical film comprising a resin and birefringent needle-shaped particles, the resin being added with the birefringent needle-shaped particles and being stretched to form the optical film (hereafter designated as Optical Film A), wherein

(i) the resin exhibits a positive birefringence along a stretching direction when stretched;

(ii) the birefringent needle-shaped particle exhibits a negative birefringence along the stretching direction of the optical film; and

(iii) the optical film satisfies the following relationships:
ny(a)<nz(a)<nx(a)
105 nm≦Ro(a)≦350 nm
0.2<Nz<0.7
wherein Ro(a) and Nz are defined as follows:
Ro(a)=(nx(a)−ny(a))×d Equation (i)
Nz=(nx(a)−nz(a))/(nx(a)−ny(a)) Equation (ii)
wherein y represents the stretching direction of the resin film, ny(a) represents an in-plane refractive index of the optical film along the stretching direction, nx(a) represents an in-plane refractive index of the optical film along a direction orthogonal to the stretching direction, nz(a) represents an refractive index of the optical film along a thickness direction of the optical film, and d represents a thickness (nm) of the optical film.
(2) The optical film of Item (1), wherein a retardation value Rth(a) defined by Equation (iii) is in the range of −30 nm≦Rth(a)≦+20 nm:
   Rth(a)={(nx(a)+ny(a))/2−nz(a)}×d Equation (iii)
(3) The optical film of Item (1) or Item (2), wherein the resin comprises a cellulose ester.
(4) A polarizing plate comprising the optical film of any one of Items (1) to (3), wherein a slow axis of the optical film is set substantially parallel to or substantially orthogonal to an absorption axis of a polarizing element of the polarizing plate.
(5) An in-plane switching mode liquid crystal display, wherein at least one of polarizing plates provided on both surfaces of an in-plane switching mode liquid crystal cell is the polarizing plate of Item (4).
(6) An in-plane switching mode liquid crystal. display comprising:

an in-plane switching mode liquid crystal cell; and

two polarizing plates provided on both surfaces of the liquid crystal cell, each polarizing plate comprising a polarizing element and a polarizing plate protective film sandwiched between the polarizing element and the liquid crystal cell,

wherein one of the polarizing plate protective films (hereafter designated as Optical Film A) is a stretched resin film and satisfies the following relatioships:
ny(a)<nz(a)<nx(a)
105 nm≦Ro(a)≦350 nm
0.2<Nz<0.7
wherein Ro(a) and Nz are defined as follows:
Ro(a)=(nx(a)−ny(a))×d Equation (iv)
Nz=(nx(a)−nz(a))/(nx(a)−ny(a)) Equation (v)

wherein y represents a stretching direction of the resin film, ny(a) represents an in-plane refractive index of the optical film along the stretching direction, nx(a) represents an in-plane refractive index of the optical film along a direction orthogonal to the stretching direction, nz(a) represents an refractive index of the optical film along a thickness direction of the optical film, and d represents a thickness (nm) of the optical film.
(7) The in-plane switching mode liquid crystal display of Item (6), wherein Optical Film A is a stretched resin film containing birefringent needle-shaped particles, wherein

(i) a resin contained in Optical Film A exhibits a positive birefringence along a stretching direction when stretched;

(ii) the birefringent needle-shaped particle exhibits a negative birefringence along the stretching direction of the resin film.
(8) The in-plane switching mode liquid crystal display of Item (6) or Item (7), wherein the polarizing plate protective film other than Optical Film A (hereafter designated as Optical Film B) satisfies the following relationships:
   −15 nm≦Ro(b)≦15 nm
   −15 nm≦Rth(b)≦15 nm
   wherein Ro(a) and Rth(b) are defined as follows:
   Ro(b)=(nx(b)−ny(b))×d Equation (vi)
   Rth(b)={(nx(b)+ny(b))/2−nz(b)}×d Equation (vii)
   wherein ny(b) represents an in-plane refractive index of Optical Film B along the stretching direction, nx(b) represents an in-plane refractive index of the optical film along a direction orthogonal to the stretching direction, nz(b) represents an refractive index of the optical film along a thickness direction of the optical film, and d represents a thickness (nm) of the optical film.

According to the present invention, provided are an optical film, a polarizing plate and an in-plane switching (IPS) mode liquid crystal display, in which two polarizing plates exhibiting different optical properties are employed in the IPS mode liquid crystal display and the viewing angle property of the IPS mode liquid crystal display is further improved.

The best modes for carrying out the present invention will now be described in detail below, but the present invention is not limited thereto.

The optical film according to the present invention is characterized in that the optical film containing a resin having positive birefringence along the stretching direction and a needle-shaped birefringent particle having negative birefringence along the stretching direction, hereinafter defined as Optical Film A, which satisfies the relation of nₓ(a)>n_{z}(a)>n_{y}(a) when y is the stretching direction, a retardation value Rₒ (a) represented by the following Equation (i) satisfies the relation of 105 nm≦Rₒ(a)≦350 nm and N_{z} represented by the following Equation (ii) satisfies a relationship of 0.2<N_{z}<0.7.
Rₒ(a)=(nₓ(a)−n_{y}(a))×d Equation (i)
N_{z}=(nₓ(a)−n_{z}(a))/(nₓ(a)−n_{y}(a)) Equation (ii)

In the above, n_{y}(a) is a refractive index along the stretching direction, nₓ(a) is a refractive index in the direction crossed at right angle with the direction of y in the film plane, n_{z}(a) is a refractive index in the thickness direction of the film and d is a thickness of the film in nm.

The Ro(a) of Optical Film A is preferably 120 nm≦Rₒ(a)≦300 nm and the Rₜₕ is preferably −30 nm≦Rₜₕ≦+20 nm from the viewpoint of widening the viewing angle.

The optical film of the present invention is preferably obtained as a roll film produced by a solution casting method or a melt casting method. The stretching direction is a direction of stretching given in the producing process of Optical Film A, when the stretching is a uniaxial stretching, while the stretching direction is a direction in which a stretching with a higher stretching ratio is carried out, when the stretching is perform in the two different directions. In Optical Film A of the present invention, it is preferable that the stretching direction is the transverse direction of the film (namely a width direction of the roll film).

The polarizing plate of the present invention is characterized in that the above optical film is employed as the protective film and the slow axis of the optical film is provided so that the slow axis of the optical film is substantially parallel or substantially orthogonal to the absorbing axis of the polarizing element.

The inventors have prepared the optical film containing the resin having positive birefringence along the stretching direction and the needle-shaped birefringent particle having negative birefringence along the stretching direction. In the optical film, selection and combination of the resin and the birefringent needle-shaped particle are controlled so that the refractive index n_{y}(a) along the stretching direction y, the refractive index nₓ(a) in the direction orthogonal to y in the film plane and the refractive index n_{z}(a) in the thickness direction of the film satisfy the relation of nₓ(a)>n_{z}(a)>n_{y}(a) and the retardation value Ro(a) represented by the foregoing Equation (i) is 105 nm≦Rₒ(a)≦350 nm and the N_{z} represented by the foregoing Equation (ii) is within the range of 0.2<N_{z}<0.7. And then the polarizing plate using the optical film as the polarizing plate protective film is prepared and provided to an IPS mode liquid crystal display. Thus it was found that the viewing angle property can be considerably improved.

Further, it was found that an IPS mode liquid crystal display further improved in the viewing angle property was obtained when one of the polarizing plates provided on both sides of the liquid crystal cell was the abovementioned polarizing plate and, on the other surface of the liquid crystal cell, a polarizing plate protective film (hereafter referred to as Optical Film B) of the other polarizing plate was provided, where Optical Film B satisfied the following relations: −15 nm≦Rₒ(b)≦15 nm and −15 nm≦Rₜₕ(b)≦15 nm. Further, since the optical film of the present invention exhibits excellent flatness, leakage of light is reduced and superior displaying quality is obtained.

(Center-Line Average Roughness of Optical Film)

When the optical film is employed for a material of LCD, high flatness is required for reducing leakage of light. The center-line average roughness (Ra) is a value defined by JIS B 0601 and is measured by, for example, a stylus method or an optical method.

The center line average roughness (Ra) of the optical film of the present invention is preferably not more than 20 nm, more preferably not more than 10 nm, and specifically preferably not more than 3 nm.

Optical Film A according to the present invention is described below.

It has been known that resin is oriented along the stretching direction and exhibits birefringence such as that described in JP-A No. 8-110402, paragraph [0007] to [0020]). Regarding cellulose ester, Preprint for Discussion 2003 of Japanese Liquid Crystal Society, p. 397 discloses that the birefringence and the wavelength scattering of cellulose n-alkylacylate sheet are varied depending on the variation of the carbon number of the alkyl group of the acyl group and the substitution degree.

Optical Film A of the present invention preferably contains at least one kind of resin having positive birefringence along the stretching direction.

The presence of the positive birefringence along the stretching direction of a resin can be measured by the following test method.

(Method for Testing Birefringence of Resin)

A resin is dissolved in a solvent and formed in a film via a solution casting method followed by drying by heating. The birefringence is evaluated on a film having a transmittance of not less than 80%.

The refractivity is measured by an Abbe refractometer 4T produced by Atago Co., Ltd., using multi-wavelength light. The refractive index along the stretching direction and that in the direction orthogonal to the stretching direction are defined as n_{y} and nₓ, respectively. The resin is decided to be positively birefringent along the stretching direction when n_{y} and nₓ each measured at 550 nm satisfy the relation of (n_{y}−nₓ)>0 in the film plane.

The resin usable in the present invention is preferably ones each easily produced, uniform in optical properties and optically transparent in addition to that the resin has positive birefringence. Any resin is usable as long as it has the above characteristics, for example, cellulose ester resins, polyester resins, polycarbonate resins, polyallylate resins, polysulfone (including polyethersulfone) resins, polyethylene resins, norbornene resins, cycloolefin resins and acryl resins can be cited, but the resin is not limited thereto. Among them, cellulose ester resins, polycarbonate resins and cycloolefin resins are preferable for the resin of the optical film of the present invention, and the cellulose ester resins are specifically preferable in the present invention from the viewpoints of productivity, cost, transparency, uniformity and adhesiveness.

In the optical film of the present invention, the cellulose ester is preferable, which can exhibit wettability the same as or similar to that of conventional TAC film when the resin is applied for the polarizing plate protective film.

The optical film of the present invention using the cellulose ester is preferable since the film can be made hydrophilic by alkali saponification and the saponified film can be pasted as the protective film with a polyvinyl alcohol polarizing element using a polyvinyl alcohol adhesive.

When the optical film is used as a polarizing plate protective film, the cellulose ester film typically a cellulose triacetate film is preferable because a well known PVA adhesive can be used for pasting the cellulose ester film with a polarizing element containing a polyvinyl alcohol film stretched together with iodine, where the surface of the cellulose ester film is subjected to a known alkali saponification treatment to form a hydrophilic surface. This technique is preferable because the characteristics of the cellulose ester film can be utilized to the maximum extent via surface modification due to the saponification treatment.

The cellulose ester specifically suitable for the optical film of the present invention is described below. When the cellulose ester is employed as the resin in the present invention, the acyl groups may be the same or different. The substitution degree can be varied for obtaining the objective birefringence. Plural structural materials each different in the substitution degree may be mixed and plural kinds of structural materials also may be mixed.

(Cellulose Ester)

The substitution degree and the composition of the cellulose ester are important in the cellulose ester having the positive birefringence along the stretching direction, although the cellulose ester usable in the present invention is not specifically limited. Cellulose molecule is composed of plural glucose units connected with each other and each of the glucose units has three hydroxyl groups. The number of acyl groups introduced to the three hydroxyl groups is referred to as a substitution degree of acyl group or an acyl substitution degree. In cellulose triacetate, acetyl groups are bonded to the entire three hydroxyl groups.

The cellulose ester usable in the present invention is the ester of a carboxylic acid having approximately 2 to 22 carbon atoms. The cellulose ester may also be an aromatic carboxylic acid ester. Specifically preferable is a lower fatty acid ester of cellulose. The lower carboxylic acid in the lower carboxylic acid ester of cellulose is a fatty acid having 6 or less carbon atoms. The acyl group to be bonded to the hydroxyl group may be one having a straight chain, a branched chain or that forming a ring. The acyl group may further have another substituent. The birefringence is lowered accompanied with increasing in the number of the carbon atom when the substitution degree is the same. Therefore, the carbon number in the acyl group is preferably selected from 2 to 6. The carbon number is preferably from 2 to 4 and more preferably 2 or 3.

In the cellulose ester, acyl groups derived from a mixture of acids are also employable, and specifically preferable is to use mixed acyl groups having 2 and 3 carbon atoms, or to use mixed acyl groups having 2 and 4 carbon atoms. A mixed fatty acid ester of ester containing propionate or butyrate additionally to an acetyl group such as cellulose acetate propionate, cellulose acetate butyrate, and cellulose acetate propionate butyrate is specifically preferably employed as the cellulose ester to be used in the present invention. The butyryl group forming the butyrate may be a straight chain or branched chain butyl group. In the present invention, cellulose acetate, cellulose acetate butyrate, cellulose acetate propionate and cellulose acetate phthalate are preferably employed.

The retardation value according to the present invention can be obtained by suitably controlling the kind of acyl group and the substitution degree of acyl group to the pyranose ring of the structure of the cellulose resin.

Cellulose ester simultaneously satisfying the following Expressions (1) and (2) is preferable in the present invention.
2.4≦(X+Y) ≦2.8 Expression (1)
0≦X≦2.5 Expression (2)

In the expressions, X is a substitution degree of an acetyl group, Y is a substitution degree of a propionyl group and/or a butyryl group. Ones satisfying the above two expressions are useful for producing a cellulose ester film having superior optical properties suitable for attaining an object of the present invention.

Among them, cellulose acetate propionate is specifically preferable for use and ones satisfying 1.5≦X≦2.3 and 0.1≦Y≦0.9 are preferable. The substitution degree can be measured according to ASTM-D817-96.

When the substitution degree is too low, unreacted hydroxyl group in the pyranose ring constituting the structure of the cellulose ester resin is increased and the abilities for protecting the liquid crystal element and for suppressing variation in the retardation values caused by humidity are lowered due to the remaining large number of the hydroxyl group.

The number average molecular weight of the cellulose ester to be used in the present invention is preferably 30,000 to 300,000, and more preferably 60,000 to 300,000, whereby high mechanical strength of the film can be obtained. The number average molecular weight is further more preferably 70,000 to 200,000.

The number average molecular weight of the cellulose ester can be measured by the following procedure.

The measurement is carried out by high-performance liquid chromatography under the following conditions.

Solvent: Acetone

Column: MPW×1 (manufactured by Toso Corp.

Sample concentration: 0.2 weight/volume percent

Flowing rate: 1.0 ml/minute

Injection amount of sample: 300 μl

Standard sample: Standard polystyrene

Temperature: 23° C.

As the raw material of cellulose for the cellulose ester to be employed in the present invention, cotton linter, wood pulp and kenaf can be cited though the material is not specifically limited. These raw materials may be used in combination in an optional mixing ratio.

Regarding the cellulose ester relating to the present invention, the reaction is carried out using an organic acid such as acetic acid, an organic solvent such as methylene chloride and a proton catalyst such as sulfuric acid when the acylating agent for the cellulose of raw material is an acid anhydride such as acetic anhydride, propionic anhydride and butylic anhydride. The reaction is carried out using a basic compound such as an amine as a catalyst when the acylating agent is an acid chloride such as CH₃COCl, C₂H₅COCl and C₃H₇COCl. In concrete, the cellulose ester can be synthesized referring the method described in JP-A No. 10-45804.

In the case of acetyl cellulose, time for the acetylation reaction should be prolonged for raising the acetyl substitution degree. However, decomposition such as breaking of the polymer chain or decomposition of acetyl group is caused when the reaction time is excessively prolonged, whereby undesirable result is obtained. Consequently, the reaction time should be set within certain range for raising the acetyl substitution degree while inhibiting the decomposition in some degree. However, it is unsuitable to limit the reaction time since various reacting conditions are applied and the reaction is considerably varied according to the reacting equipment or another condition. The molecular weight distribution of the polymer is spread accompanying the progress of the decomposition. Therefore, the degree of the decomposition can be usually determined by using the value of (Weight average molecular weight (Mw))/(Number average molecular weight (Mn)) also in the case of the cellulose ester. The value of (Weight average molecular weight (Mw))/(Number average molecular weight (Mn)) can be used as one indicator of reaction degree for carrying out the acetylation reaction for sufficient time without excessive decomposition caused by excessively long reacting time. The value of Mw/Mn is preferably 1.0 to 5.0, and more preferably 1.4 to 3.0.

An example of the production method of the cellulose ester is described below. One hundred parts by weight cotton linter as the raw material of cellulose is pulverized and 40 parts by weight of acetic acid is added and subjected to preactivation treatment at 36° C. for 20 minutes. After that, 8 parts by weight of sulfuric acid, 260 parts by weight of acetic anhydride and 350 parts by weight of acetic acid are added and acetylation is carried out at 36° C. for 120 minutes. The reacting system is neutralized by 11 parts by weight of 24% aqueous solution of magnesium acetate and then ripened for saponification at 63° C. for 35 minutes to obtain acetyl cellulose. The acetyl cellulose is stirred for 160 minutes at room temperature using 10 times of an aqueous acetic acid solution (acetic acid:water=1:1 in weight), and filtered and dried to obtain purified acetyl cellulose having an acetyl substitution degree of 2.75. Thus obtained acetyl cellulose has a Mn of 92,000, an Mw of 156,000 and a ratio of Mw/Mn of 1.7. Cellulose ester different in the acetyl substitution degree or Mw/Mn can be obtained by varying the acetylation condition such as temperature, time and stirring and the hydrolysis condition.

The synthesized cellulose ester is preferably subjected to purification for removing low molecular weight component or filtration for removing non-acetylated or low acetylated component.

The mixed acid cellulose ester can be obtained by the method described in JP-A No. 10-45804. The acyl substitution degree can be measured according to the method described in ASTM-D817-96.

The cellulose ester is influenced by the presence of a minute amount of metal ingredient. It is supposed that the metal ingredient is related to water used in the production process, and the amount of the ingredient causing insoluble nuclei is preferably smaller. Therefore, the content of a metal ion such as iron, calcium and magnesium is preferably smaller. These metal ions tends to cause an insoluble substance by forming a salt with a decomposition product of polymer containing an organic acid group. The content of iron (Fe) ingredient is preferably not more than 1 ppm. The calcium (Ca) ingredient tends to form a coordination compound or complex together with an acidic component such as carboxylic acid and sulfonic acid or various ligands so as to form scum (insoluble precipitate or turbid) caused by insoluble calcium compound.

The content of calcium (Ca) is not more than 60 ppm, and preferably 0 to 30 ppm. The content of magnesium (Mg) is preferably 0 to 70 ppm, and more preferably 0 to 20 ppm because an insoluble product is formed when the content is too high. The content of metal such as iron (Fe), calcium (Ca) and magnesium (Mg) can be analyzed by a method in which the absolutely dried cellulose ester is pretreated by a microdigesting apparatus (decomposition by sulfuric acid and nitric acid) and by alkali fusion and analyzed by an inductively coupled plasma-atomic emission spectrometry ICP-AES.

(Needle-Shaped Birefringent Particle)

Optical Film A of the present invention is characterized in that the film contains at least one kind of needle-shaped particle exhibiting negative birefringence along the stretching direction.

The needle-shaped birefringent particle having negative birefringence along the stretching direction is a material having negative birefringence along the stretching direction in a medium or in other resins.

One of the objects of the present invention can be attained by that the film contains at least one kind of resin having positive birefringence along the stretching direction and at least one kind of needle-shaped birefringent particle having negative birefringence along the stretching direction. The containing ratio and the state of the resin having positive birefringence along the stretching direction and the needle-shaped particle can be suitably selected for obtaining the desired retardation.

The birefringent particle described in JP-A No. 2004-109355 can be used for the needle-shaped birefringent particle having negative birefringence along the stretching direction, hereinafter referred to as birefringent particle. Examples of the particle include various carbonate such as calcium carbonate, magnesium carbonate, manganese carbonate, cobalt carbonate, zinc carbonate and barium carbonate.

For example, preferably employed are: uniaxial birefringent crystals of, such as, tetragonal system, hexagonal system and rhombohedral system; and crystals of orthorhombic system, monoclinic system and triclinic system. These crystals may be a single crystal or a polycrystal.

A rod-shaped particle of polystyrene resin or polyacryl resin can be preferably employed, which may be, for example, a short fibrous needle-shaped particle produced by finely cutting extra thin fiber containing the polystyrene resin or the polyacryl resin. Such the fiber is preferably stretched in the course of production for giving the birefringence. Each of these resins is preferably a crosslinked resin.

In the present invention, the major diameter of a particle represents a longest length of the particle observed in an electron microscope image, and the minor diameter of the particle represents the distance between two tangent lines of the particle, both of which are parallel to the major axis of the particle, in the electron microscope image. The average diameter of particles represents a number average major diameter of at least 1000 particles observed in the electron microscope image. The birefringent particle of the present invention exhibits an average diameter in the range of 10-500 nm, and an aspect ratio defined by (major diameter/minor diameter) of preferably 1.1 or more, more preferably 2-100, and further more preferably 3-30.

The method of evaluation of the particle diameter will now be described: The obtained birefringent particles are observed by an electron microscope at a magnification of ×20,000 to obtain an image. The image is, then, scanned by personal computer CanoScanFB636U produced by Canon Inc. at 300 dpi as an monochrome image. The scanned image is further loaded in an image processing software WinROOF ver3.60 installed in personal computer Endeavor Pro720L (CPU:Athlon-1 GHz, memory size: 512 MB) produced by Epson Direct Corp.

As a pretreatment of the image, particle images in an area of 2×2 μm are extracted while the image data are automatically binarized. It is confirmed that 90% or more of particle images are extracted. If the extraction is not satisfactory, the detection level is manually adjusted so that 90% of more particle images are extracted. Further, when the number of extracted particle images are less than 1000, extraction is repeated for another 2×2 μm area. This procedure is repeated until the total number of particle images becomes 1000 or more.

However, the particle is not limited thereto and various materials can be applied as long as it satisfies the above conditions such as the size, shape and aspect ratio.

The birefringent particle is preferably subjected to a surface treatment with a silane coupling agent or a titanate coupling agent.

The birefringence of the birefringent particle is defined as follows. When the refractive index of light polarized in the direction of the major axis is nₚᵣ and the average refractive index of the direction orthogonal to the major axis is nᵥₜ, the birefringence Δn of the birefringent particle is defined by the following Equation:
Δn=nₚᵣ−nᵥₜ

Namely, the refractive index is positive when the refractive index of the birefringent particle in the major axis direction is larger than the average refractive index in the direction orthogonal to the major axis direction and the refractive index is negative when the relation of the refractive indexes is reverse.

The absolute value of the negative birefringence of the birefringent particle to be employed in the present invention is preferably from 0.01 to 0.3 and more preferably from 0.05 to 0.3, however, the absolute value of the negative birefringence is not limited thereto. In the case of the needle-shaped crystal, the negative refractive index means that the refractive index in the direction of the major axis of the crystal is smaller than that in the direction orthogonal to the major axis of the crystal.

The foregoing carbonate particle can be produced by a homogeneous precipitation method or a carbon dioxide gas method.

The carbonates can be produced by the methods described in, for example, JP-A Nos. 3-88714, 55-51852 and 59-223225.

Strontium carbonate crystal can be obtained by contacting a strontium ion and a carbonate ion in an aqueous solution. The carbonate ion can be added by bubbling into a solution containing a strontium compound or by adding and reacting or decomposing a compound capable of forming the carbonate ion. For example, the particle of strontium carbonate crystal can be produced by the method described in JP-A No. 2004-35347, and the strontium carbonate crystal particle produced by such the method is preferably employed as the birefringent particle. Urea can be employed as the substance for forming carbon dioxide gas; the strontium carbonate particle can be obtained by reacting strontium ion with carbon dioxide gas formed by urea and a urea hydrolysis enzyme. For obtaining the particles, the reaction is performed at temperature as low as possible. It is preferable to cool the reacting solution to a temperature not more than ice point, whereby minute particles can be obtained. For example, it is also preferable to add an organic solvent such as ethylene glycol as an ice point lowering agent. The organic solvent is preferably added so that the ice point becomes lower than −5° C. Strontium carbonate particles having an average diameter in the major axis direction of not more than 500 nm can be obtained by such a method.

Strontium carbonate is a biaxial birefringent crystal and JP-A No. 2004-35347 discloses that the refractive index in each of the optical directions n(nₐ, n_{b} and n_{c}) is (1.520, 1.666 and 1.996) and the major axis direction of the crystal approximately meets with the direction of the optical axis of the refractive index of 1.520. Accordingly, the crystal has negative birefringence in the orientation direction of the crystal. The strontium carbonate crystal can be statistically oriented in the designated direction by applying stress in a state of dispersed in a viscous medium since the crystal has needle-like or rod-like shape.

When the needle-shaped birefringent particles are mixed with the cellulose ester solution, Optical Film A is preferably produced by a dope prepared by using a needle-shaped birefringent particle dispersion composed of the needle-shaped birefringent particles dispersed in a needle-shaped birefringent particle dispersing resin and an organic solvent.

The molecular weight of the resin for dispersing the needle-shaped birefringent particle is preferably 3,000 to 200,000, and more preferably 3,000 to 90,000, in weight average molecular weight.

Specifically, the needle-shaped birefringent particle dispersing resin is preferably at least one selected from: homopolymers and copolymers each having an ethylenically unsaturated monomer unit; homopolymers and copolymers of acrylate or methacrylate; homopolymers and copolymers of methyl methacrylate; cellulose esters; cellulose ethers; polyurethane resins; polycarbonate resins; polyester resins; epoxy resins; and ketone resins. It is preferable that the cellulose ester has a total acyl substitution degree of from 2.0 to 2.8.

These resins enable forming a uniform film inhibited in occurrence of haze even when each of the resins is contained in a high concentration (cellulose content of 10 to 30% by weight) cellulose ester solution, namely a dope, to be employed for solution casting film forming process. The concentration of the needle-shaped birefringent particle dispersing resin in the needle-shaped birefringent particle dispersion is preferably not less than 0.1% by weight but less than 10% by weight, and more preferably 0.2 to 5% by weight, though the concentration is varied depending on the kind of the resin.

In the present invention, the viscosity of the particle dispersion is preferably controlled within the range of 100 to 500 mPa·s.

It is commonly carried out that the same cellulose ester as that used in the cellulose ester solution is added to the particle dispersion to increase the viscosity of the dispersion. In such the case, however, the production efficiency is considerably lowered because the dispersibility of the particles is degraded and many coagulates are caused so that the final filtration tends to be blocked and exchange of the filter is frequently required. It is supposed that such the phenomenon is caused by a high weight average molecular weight of 120,000 to 600,000 of the cellulose ester and the low affinity of the cellulose ester to the particles, although several reasons can be considered for such the phenomenon.

As a result of investigation by the inventors on the kind and the molecular weight of the resins, it has been found that the following resins are preferably employed and that, when the weight average molecular weight is controlled within 3,000 to 90,000, (i) varieties of resins can be utilized; (ii) the dispersing state of the particle dispersion is considerably improved; and (iii) the compatibility with the cellulose ester solution is also improved and a dope without coagulates is obtained. The weight average molecular weight is more preferably 5,000 to 50,000, and further more preferably 10,000 to 36,000. Known reins are widely usable without any limitation, however, preferable are the resins listed below.

As the resin preferably to be used in the particle dispersion, homopolymers and copolymers having an ethylenically unsaturated monomer can be cited. The resin is preferably a homopolymer or a copolymer of acrylate or methacrylate such as poly(methyl acrylate), poly(ethyl acrylate), poly(propyl acrylate), poly(cyclohexyl acrylate), a copolymer of alkyl acrylate, poly(methyl methacrylate), poly(ethyl methacrylate), poly(cyclohexyl methacrylate) and a copolymer of alkyl methacrylate. The acrylate and the methacrylate are superior in the transparency and the compatibility and the homopolymers and copolymers having an acrylate or methacrylate unit, specifically homopolymers or copolymers having a methyl acrylate or methyl methacrylate unit, are preferable. In concrete, poly(methyl methacrylate) is preferable. An alicyclic ester of acrylic acid or methacrylic acid such as poly(cyclohexyl acrylate) or poly(cyclohexyl methacrylate) is preferable because these compounds have advantages such as high heat resistivity, low hygroscopicity and low birefringence.

Examples of other resins include a cellulose ester resin having an acyl substitution degree of from 2.0 to 2.80 such as cellulose acetate, cellulose acetate propionate and cellulose acetate butyrate; a cellulose ether resin having an alkyl substitution degree of from 2.0 to 2.80 such as cellulose methyl ether, cellulose ethyl ether, and cellulose propyl ether; a polyester resin such as a polyamide resin of copolymer of an alkylenediol and a diamine; a polymer of an alkylene dicarboxylic acid and a diol, a polymer of an alkylene diol and a dicarboxylic acid, a polymer of a cyclohexanedicarboxylic acid and a diol, a polymer of cyclohexanediol and a dicarboxylic acid and a polymer of an aromatic cicarboxylic acid and a diol; a vinyl acetate resin such as polyvinyl acetate and a copolymer of vinyl acetate; a polyvinyl acetal resin such as polyvinyl acetal and polyvinyl butyral; an epoxy resin such as that described below, a ketone resin such as that described below and a polyurethane resin such a linear polymer of an alkylene diisocyanate and an alkylenediol as shown below. At least one selected from the above-mentioned is preferably contained. The epoxy resin is a resin formed by ring-opening reaction of a compound having two or more epoxy groups in the molecular thereof and the followings can be exemplified. Typical products available on the market include Araldite EPN 1179 and Araldite AER 260, manufactured by Asahi Ciba Co., Ltd. Araldite EPN 1179 has a weight average molecular weight of about 405. The following n represents polymerization degree.

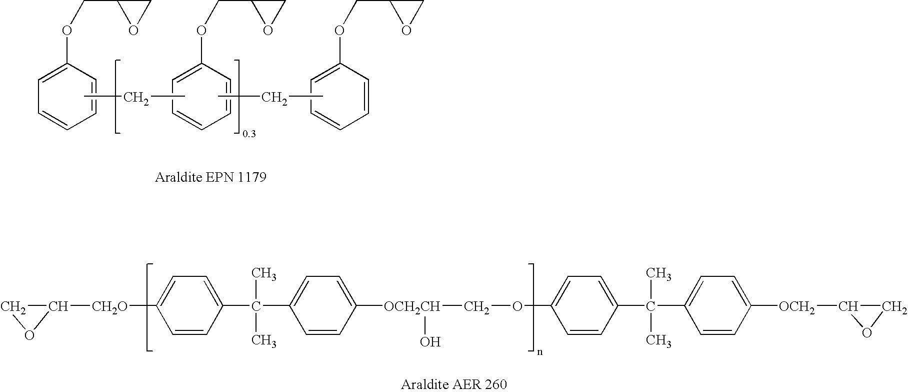

The ketone resin is a resin obtained by polymerizing a vinyl ketone and the following ketone resins can be exemplified. Typical products available on the market include Highlac 110 and Highlac 110H, manufactured by Hitachi Kasei Co., Ltd. The following n represents polymerization degree.

Highlac 110

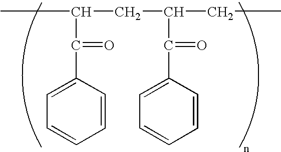

Highlac 110H

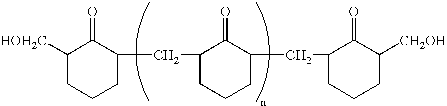

The dispersing ability of the particles can be improved and the particle dispersion almost not containing coagulum can be formed by using the above resin and applying the later-mentioned dispersing method even when the molecular weight is the outside of the foregoing range or the weight average molecular weight (a weight average molecular weight of less than 3,000 or more than 90,000).

The above-mentioned resins are each easily employed when the weight average molecular weight thereof is smaller and that of the resin is preferably approximately from 300 to 40,000, more preferably from 500 to 20,000, and further preferably from 5,000 to 20,000 though the resins can be used without any limitation of the weight average molecular weight. The resin having smaller weight average molecular weight is superior in the compatibility with the cellulose ester of the dope and in the dispersing ability of the particles. Alternatively, the resin having larger weight average molecular weight can control the viscosity of the particle dispersion only with a small amount.

In the present invention, the content of the particle in the particle dispersion is preferably 0.1 to 2.0% by weight based on the weight of the organic solvent. The concentration of the resin depends on the molecular weight thereof, however, it is preferably approximately 5 to 50% by weight based on the weight of the organic solvent.

As the organic solvent, an organic solvent useful for dissolving the cellulose ester for preparing the dope is preferably employed.

The dispersing machine to be used for preparing the foregoing particle dispersion of the present invention can be roughly classified into a dispersing machine using no medium and a dispersing machine using a medium, and both of them are applicable. As the dispersing machine using no medium, Manton-Gaulin homogenizer utilizing high pressure is cited. Examples of the dispersing machine using a medium include a sand mill and a ball mile in which collision force of media such as glass beads or ceramic beads is utilized. The dispersing machine using no medium is specifically preferable in which mixing of broken piece of the media is not caused.

The needle-shaped birefringent particle is preferably added by an in-line adding means together with the later-mentioned matting agent, by which the particles are uniformly dispersed in the film, though the adding method is not specifically limited.

(Additives)

In the optical film of the present invention, the following various additives can be employed.

An additive such as a plasticizer, a UV absorbent, an antioxidant, a dye, a matting agent and a retardation controlling agent is added into the dope for producing the optical film.

Such the compounds may be either added on the occasion of preparation, in the course of preparation or after the preparation of the cellulose ester solution. Specifically, for the film to be used for liquid crystal display, the plasticizer for giving resistivity to heat and humidity, the antioxidant and the UV absorbent are preferably added additionally to the retardation controlling agent for improving the optical property.

(Plasticizer)

A compound known as plasticizer, preferably a phosphate ester or a carboxylate ester, is preferably added to the optical film of the present invention for improving the mechanical strength, providing softness and anti-moisture absorption property, reducing water vapor permeation rate and controlling retardation. A polymer obtained by polymerizing an ethylenically unsaturated monomer and having a weight average molecular weight of 500 to 10,000 described in JP-A No. 2003-12859 (Japanese Patent Application No. 2001-198450), an acrylic polymer and an acrylic polymer having an aromatic ring or a cyclohexyl group on the side chain are also preferably employed. Examples of the phosphate ester include triphenyl phosphate, tricresyl phosphate and phenyl diphenyl phosphate. The carboxylate ester include a phthalate ester and a citrate ester. Examples of the phthalate ester include dimethyl phthalate, diethyl phthalate, dicyclohexyl phthalate, dioctylphthalate and diethylhexyl phthalate. Examples of the citrate ester include acetyltriethyl citrate and acetyltributyl citrate. Butyl oleate, methylacetyl ricinolate, dibutyl sebacylate, triacetine and trimethylolpropane benzoate are also cited. An alkylphthalyl alkyl glycolate is also preferably employed for such the purposes. The alkyl group of the alkylphthalyl alkyl glycolate is an alkyl group having 1 to 8 carbon atoms. Examples of the alkylphthalyl alkyl glycolate include methylphenalyl methyl glycolate, ethylphthalyl ethyl glycolate, propylphthalyl propyl glycolate, butylphthalyl butyl glycolate, octylphthalyl octyl glycolate, methylphthalyl ethyl glycolate, ethylphthalyl methyl glycolate, ethylphthalyl propyl glycolate, propylphthalyl ethyl glycolate, methylphthalyl propyl glycolate, methylphthalyl butyl glycolate, ethylphthalyl butyl glycolate, butylphthalyl methyl glycolate, butylphthalyl ethyl glycolate, propylphthalyl butyl glycolate, butylphthalyl propyl glycolate, methylphthalyl octyl glycolate, octylphthalyl methyl glycolate and octylphthalyl ethyl glycolate. Among them, methylphthalyl methyl glycolate, ethylphthalyl ethyl glycolate, propylphthalyl propyl glycolate, butylphthalyl butyl glycolate and octylphthalyl octyl glycolate are preferable, and ethylphthalyl ethyl glycolate is specifically preferably employed. Two or more kinds of these alkylphthalyl alkyl glycolates may be mixed for the use.

The adding amount of the plasticizer is preferably 1 to 20% by weight based on the weight of the cellulose ester in order to obtain the objective effect while preventing bleeding out of the plasticizer from the film. The plasticizer is preferably one having a vapor pressure of not more than 1333 Pa at 200° C. of for preventing the bleeding out since the temperature during the casting and drying is raised until about 200° C.

(UV Absorbent)

As the UV absorbent to be employed in the present invention, oxybenzophenone compounds, benzotriazole compounds, salicylate compounds, benzophenone compounds, cyanoacrylate compounds and nickel complex compounds can be cited. Among them, the benzotriazole compounds are preferable which exhibits only limited coloring effect. The UV absorbents described in JP-A No. 10-182621 and 8-337574 and polymer UV absorbents described in JP-A No. 6-148430 are preferably usable. A UV absorbent excellent in the absorbing ability to UV rays of wavelength of not more than 370 nm is preferable from the viewpoint of anti-degradation effect to the polarizing element and the liquid crystal.

Alternatively, a UV absorbent exhibiting low absorption to visible light of wavelength of not less than 400 nm is preferable from the viewpoint of visibility of the liquid crystal display.

Concrete examples of the UV absorbent useful for the present invention include 2-(2′-hydroxy-5-methylphenyl)-benzotriazole, 2-(2′-hydroxy-3′,5′-di-tert-butylphenyl)-benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidemethyl)-5′-methylphenyl)-benzotriazole, 2,2-methylene-bis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazole-2-yl)-6-(strait- or branched-chain dodecyl)-4-methylphenol and a mixture of octyl-3-[3-tert-butyl-4-hydroxy-5-(chloro-2H-benzotriazole-2-yl)-phenyl]propionate and 2-ethylhexyl-3-[3-tert-butyl-4-hydroxy-5-(5-chloro-2H-benzotriazole-2-yl)phenyl]-propionate, but the UV absorbent is not limited thereto. Tinuvin 109, 171 and 326, each manufactured by Ciba Specialty Chemicals Co., Ltd., available on the market are preferably usable.

Concrete examples of the benzophenone compounds include 2,4-hydroxybenzophenone, 2,2′-dihydroxy-4-methoxybenzophenone, 2-hydroxy-4-methoxybenzophenone, 2-hydroxy-4-methox-5-sulfobenzoophenone and bis(2-methoxy-4-hydroxy-5-benzoylphenylmethane. But the compound is not limited thereto.

In the present invention, the benzotriazole UV absorbent and the benzophenone UV absorbent are preferably employed which have high transparency and is superior in the effect of preventing the degradation of the polarizing plate and the liquid crystal element, and the benzotriazole UV absorbent exhibiting less unnecessary coloring is specifically preferable. Though any method can be applied for adding the UV absorbent to the dope as long as the UV absorbent can be dissolved in the dope, a method is preferable in which the UV absorbent is dissolved in a good solvent for the cellulose ester such as methylene chloride, methyl acetate and dioxoran or a mixture of the good solvent and a poor solvent such as a lower aliphatic alcohol, for example, methanol, ethanol, propanol and butanol, and mixed with the cellulose ester solution to prepare the dope. The solvent composition of the UV absorbent solution is preferably the same as or close to the solvent composition of the dope. The content of the UV absorbent is preferably 0.01 to 5% by weight, and more preferably 0.5 to 3% by weight.

(Antioxidant)

As the antioxidant, hindered phenol compounds are preferably employed. Examples of such the compound include 2,6-di-t-butyl-p-cresol, pentaerythityl-tetrakis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3,5-di-t-butyl-4-hydroxyphenyl)-propionate, 2,4-bis(n-octyl)-6-(4-hydroxy-3,5-di-t-butylanilino)-1,3,5-triazine, 2,2-thio-diethylene-bis[3-(3,5-t-butyl-4-hydroxyphenyl)propionate, octadecyl-3-(3,5-di-t-butyl-4-hydroxyphenyl)propionate, N,N′-hexamethylene-bis(3,5-di-t-butyl-4-hydroxy-4-hydroxy-hydrocinnamide), 1,3,5-trimethyl-2,4,6-tris(3,5-di-t-butyl-4-hydroxybenzyl)benzene and tris(3,5-di-t-butyl-4-hydroxybenzyl)-isocyanurate. Specifically, 2,6-di-t-butyl-p-cresol, pentaerythityl-tetrakis[3-(3,5-di-t-butyl-4-hydroxyphenyl)propionate] and triethylene glycol-bis[3-(3-t-butyl-5-methyl-4-hydroxyphenyl)-propionate] are preferred. A hydrazine metal inactivation agent such as N,N′-bis[3-(3,5-di-t-butyl-4-hydroxyphenyl)propionyl]hydrazine and a phosphor processing stabilizing agent such as tris(2,4-di-t-butylphenyl)phosphite may be used in combination. The adding amount of these compounds is preferably 1 ppm to 1.0%, and more preferably from 10 ppm to 1,000 ppm, by weight based on the weight of the cellulose ester.

(Retardation Controlling Agent)

Aromatic compounds having two or more aromatic rings such as those described in European Patent No. 911,656A2 can be used for controlling the retardation.

Two or more kinds of the aromatic compounds may be employed in combination. The aromatic rings of the aromatic compound include an aromatic heterocyclic ring in addition to an aromatic hydrocarbon ring. The aromatic heterocyclic ring is specifically preferred and the aromatic heterocyclic ring is usually an unsaturated heterocyclic ring. Among the unsaturated heterocyclic rings, a 1,3,5-triazine ring is specifically preferred. Compounds having two or more kinds of 1,3,5-triazine ring may be used in combination. Two or more kinds of disc-shaped compound such as a compound having 1,3,5-triazine ring and a compound having a porphyrin structure may be employed in combination.

(Matting Agent)

In the present invention, the transportation and winding of the film can be made easy by adding a matting agent into the cellulose ester film. The particle of the matting agent is preferably as small as possible. Examples of the particle include an inorganic particle of silicone dioxide, titanium dioxide, aluminum oxide, zirconium oxide, calcium carbonate, kaolin, talk, baked calcium silicate, hydrated calcium carbonate, aluminum silicate and magnesium silicate, and a particle of crosslinked polymer. Among them, silicone dioxide is preferred by which the haze of the film can be reduced.

The particle such as silicone dioxide is often surface treated with an organic compound, which is preferable since haze of the film can be reduced.

As preferable organic compound for the surface treatment, a halosilane compound, an alkoxysilane compound, a silazane compound and a siloxane compound are cited. The particle having larger average diameter shows larger slipping effect and that having smaller average diameter is superior in the transparency. The average diameter of the secondary particles is ordinary in the range of 0.05 μm to 1.0 μm. The average diameter of the secondary particles is preferably 5 nm to 50 nm, and more preferably from 7 nm to 14 nm. These particles are preferably employed in order to form irregularity of 0.01 μm to 1.0 μm on the surface of the cellulose ester film. The content of the particle in the cellulose ester is preferably 0.005 to 0.3% by weight based on the weight of the cellulose ester.

As the particle of silicone dioxide, Aerosil 200, 200V, 300, R972, R972V, R974, R202, R812, OX50, and TT600, each manufactured by Nihon Aerosil Co., Ltd., are usable. Aerosil 200V, R972, R972V, R974, R202 and R812 are preferable. Two or more kinds of these particles may be employed in combination. In such the case, the particles each different in the average diameter or the material, for example Aerosil 200V and R972 can be combined in a weight ratio of 0.1:99.9 to 99.9:0.1.

The matting agent may be added only into the surface layer on one of the surfaces when the orientation is hindered by the irregularity caused by the matting agent on the occasion of coating the orientation layer or the liquid crystal layer. The friction coefficient can be reduced and the slipping ability can be improved by coating a coating liquid containing the matting agent and cellulose ester such as diacetyl cellulose, cellulose acetate propionate.

(Other Additives)

In addition to the above, an inorganic particle such as that of kaolin, talk, diatomite, quartz, calcium carbonate, barium sulfate, titanium oxide and alumina, a thermal stabilizer such as a salt of alkali-earth metal such as calcium and magnesium may be added. An antistatic agent, a flame retardant, a slipping agent and an oily agent may further be added occasionally.

(Organic Solvent)

The organic solvent useful for dissolving the cellulose ester to prepare the dope includes chlorine-containing solvents and non-chlorine solvents. As the chlorine-containing solvent, methylene chloride is suitable for dissolving the cellulose ester specifically cellulose triacetate. Recently the use the non-chlorine solvent has been considered from the viewpoint of environmental problems. Examples of the non-chlorine solvent include methyl acetate, ethyl acetate, amyl acetate, acetone, tetrahydrofuran, 1,3-dioxofuran, 1,4-dioxan, cyclohexanone, ethyl formate, 2,2,2-trifluoroethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol and nitroethane. When these organic solvents are used for dissolving cellulose triacetate, various dissolving methods such as a high temperature dissolution method, a cooling dissolution method and a high pressure dissolution method are preferably applied by which insoluble substance can be reduced, while the dissolution method at room temperature is also applicable. Methyl acetate, ethyl acetate and acetone are preferably employed for cellulose esters other than the cellulose triacetate, although methylene chloride is also usable. Of these, methyl acetate is specifically preferable. In the present invention, the solvents having high dissolving ability to the above cellulose esters are referred to as good solvent, and the solvent exhibiting highest dissolving effect and used in major amount is referred to as a principal organic solvent. The good solvent in the present invention is a solvent capable of dissolving not less than 5 g of cellulose ester in 100 g of the solvent at 25° C.

The dope employed in the present invention preferably contains an alcohol having 1 to 4 carbon atoms in an amount of 1 to 40% by weight additionally to the foregoing organic solvent. The alcohols are used as a gelling agent by which the web is gelled and strengthen when the dope is cast on a metal support and the alcohol content is increased due to the evaporation of other solvent. As a result of that the web can be easily peeled off from the metal support. The alcohol also plays a role of accelerating dissolution of the cellulose ester in the non-chlorine organic solvent when the alcohol content is low. Examples of the alcohols having 1 to 4 carbon atoms include, methanol, ethanol, n-propanol, iso-propanol, n-butanol, sec-butanol and tert-butanol. Among them, ethanol is preferable, which is superior in the points of stability of dope, low boiling point, drying ability and no toxicity. These organic solvents are included in the category of poor solvent because the dissolving ability to the cellulose ester is low. In the present invention, the poor solvent is a solvent capable of dissolving less than 5 g of cellulose ester in 100 g of the solvent at 25° C.

For improving the surface quality of the film, it is preferable to control the concentration of the cellulose ester in the dope in the range of 10 to 40% by weight and the viscosity of the dope in the range of 10 to 50 Pa·s.

(Production Method of Optical Film A)

Optical Film A can be produced by known solution-casting method or melt-extruding method.

When Optical Film A is produced by the solution-casting method, the film containing. the needle-shaped birefringent particles can be produced by adding the birefringent particles preferably in the state of the dispersion to the solution of the cellulose ester constituting the film, the solvent containing no cellulose resin or a dispersion containing another dispersed substance.

Optical Film A is preferably produced by a method in which the dope prepared by dissolving the cellulose ester is cast on a support such as a stainless steel belt and the film is peeled off from the belt, and then the film is stretched in the transverse direction and dried while conveying in a drying zone. The solution-casting method is described below. The longitudinal direction, hereinafter also referred to as MD, is the direction of transportation in the casting machine and the transverse direction, hereinafter also referred to as TD, is the direction orthogonal to the longitudinal direction in the film plane.

<<Solution-Casting Method>>

(a) Dissolving Process:

This process is a process for producing a dope in which cellulose ester in a state of flakes, powder or granules preferably particles having an average diameter of not less than 100 μm, and additives are dissolved in a solvent mainly constituted by a good solvent for the cellulose ester while stirring. Various methods such as a method carried out under ordinary pressure, a method carried out at a temperature less than the boiling point of the good solvent, a method carried out under high pressure at a temperature more than the boiling point of the good solvent, a method carried out by a cooling dissolution method and a method carried out at high pressure can be applied for the dissolution. The dissolved dope is filtered and defoamed, and then transported to the next process by a pump.

The foregoing dope is a solution in which the cellulose ester according to the present invention, the needle-shaped birefringent particles and the additives are dissolved in the organic solvent.

(b) Casting Process:

In this process, the dope is transported to a pressure die through a high pressure metering pump and cast from the pressure die onto the casting position of a metal support, for example, an endlessly moving endless metal belt such as a stainless steel belt or a rotating metal drum. The metal support has a mirror surface. As another casting method, a doctor blade method in which the thickness of the cast dope layer is controlled by a blade and a method by a reverse roll coater in which the layer thickness is controlled by a reversely rotating roller are applicable. However, the pressure die is preferable since the shape of the slit can be easily controlled so as to make uniform the thickness of the cast layer. The pressure die includes a coat hunger die and T die; both of them are preferably applicable. The dope may be divided and cast into multiple layers through two or more dies for raising the film forming speed.

(c) Solvent Evaporation Process:

In this process, the layer of the dope cast onto the metal support, hereinafter referred to as a web, is heated on the metal support for evaporating the solvent until the web can be peeled off from the support. A method by blowing air from the web side and/or heating by a liquid from the backside of the metal support and a method of heating by heat radiation to both sides are applicable for evaporating the solvent. The method by heating liquid from the backside is preferable form the viewpoint of the drying efficiency. The combination of the above methods is also preferable.

A method for raising the temperature of the web on the metal support is effective for increasing the film forming speed. However, excessive heating causes occurrence of bubbles of the solvent in the web. Therefore, the preferable drying speed is decided according to the composition of the web. The method of casting onto the metal belt support is preferably applied for raising the film forming speed. The casting speed can be raised by prolonging the length of the belt when the casting is carried out by using the metal belt support. However, the prolonging of the belt accelerates bending of the belt caused by the weight of the belt itself. The bending caused vibration on the occasion of the film formation so as to form ununiformity in the cast layer. Accordingly, the length of the belt is preferably 40 to 120 m.

(d) Peeling Process:

In this process, the web formed by evaporation of the solvent on the metal support is peeled off at the peeling position and the peeled web is transported to the next process. The peeling of the web is difficult when excessive amount of the solvent remains at the time of peeling, and a part of the web tends to be peeled halfway when the peeling is performed after sufficiently drying of the web on the metal support.

A gel casting method is applied for raising the film forming rate, by which the film forming rate can be increased because the web can be peeled off while the residual amount of the solvent is still considerably large.

The gel casting method includes: (i) a method in which a poor solvent for cellulose ester is added to the dope so that the dope is gelled after casting; and (ii) a method in which the temperature of the metal support is lowered so that the dope is gelled. In the gel casting method, the duration until peeling the web can be shorten because the strength of the web is increased by gelation of the web on the metal support.

In the present invention, the temperature of the metal support at the peeling position is preferably controlled at a temperature of 10 to 40° C., and more preferably 15 to 30° C. The reaming solvent amount in the web at the peeling position is preferably made to from 5 to 120% by weight. In the present invention, the residual amount of the solvent can be represented by the foregoing Equation (1).
Residual solvent amount (weight-%)={(M−N)/N}×100, Equation (1)
wherein M is the weight of the web at an optional point of time and N is the weight of the same sample after drying at 110° C. for 3 hours.

When the film is formed on the metal-belt support, the increasing in the belt speed accelerates vibration of the belt. The film forming rate is preferably from 10 to 120 m/minute, and more preferably from 15 to 60 m/minute, considering the residual solvent amount at the peeling time and the length of the belt.

In the present invention, the residual amount of the solvent is represented by an average residual amount regarding entire width of the web, or local residual amount such as a residual amount in the central portion and a residual amount in the portion of both edges.

(e) Drying Process:

The web is usually dried by a drying equipment in which the web is transported by passing through staggeringly arranged rollers and/or a tenter apparatus in which the web is transported while clipping the both edges of the web. The web is usually dried by blowing hot air to both surfaces thereof, however, also applicable is a drying means for heating the web by applying micro wave in stead of blowing hot air. The drying in excessively high rate tends to lower the flatness of the film. The drying temperature is entirely within the range of from 30 to 250 ° C. The drying temperature, drying air amount and drying time are differed depending on the kind of the solvent; therefore the drying condition is suitably decided according to the kind and combination of the solvents.

In the present invention, Process D0 is a process for transporting the cast film peeled off from the support into the tenter zone. In Process D0, the temperature is preferably controlled for controlling the residual solvent amount. The temperature is preferably 20 to 70° C., more preferably 20 to 68° C., and further preferably 20 to 40° C., for controlling the residual solvent amount while preventing the stretch of the web in the transporting direction (hereinafter referred to as the longitudinal direction), though the temperature is varied according to the amount of the residual solvent.

There is a preferable temperature distribution range in the atmosphere of the film in the direction being orthogonal to the film transporting direction in the film plane (hereinafter referred to as the transverse direction). The temperature distribution in the lateral direction of the film in Process D0 is preferably not more than ±5° C., more preferably not more than ±2° C., and most preferably not more than ±1° C.

As the transportation tension for the film, there is a following preferable condition for satisfying the peeling condition and preventing the expansion in Process D0.

(Tension for Film Transportation in Process D0)

The tension for film transportation in Process D0 may be influenced by: (i) the physical properties of the dope; (ii) the residual amount of the solvent at the time of peeling and in Process D0; and (iii) the temperature in Process D0, however, the tension is preferably 30 to 300 N/m, more preferable 57 to 284 N/m, and specifically preferably 57 to 170 N/m.

A tension-cut roller is preferably provided for preventing expansion of the film in the longitudinal direction.

A suitable ratio of the good solvent to the poor solvent in Process D0 is decided for preventing the expansion of the film in the longitudinal direction. The ratio expressed by the following formula, in weight, is preferably 15 to 95% by weight, more preferably 25 to 95% by weight, and specifically preferably 30 to 95% by weight:

(Poor Solvent)/(Good Solvent+Poor Solvent)×100%,

(f) Stretching Process (also Referred to as Tenter Process):

Optical Film A exhibits birefringence by stretching.

The film can be stretched in both the following conditions: (i) the state containing the solvent when the film is produced by a solution-casting method; and (ii) the state in which the film is dried.

In the present invention, when the needle-shaped birefringent particles are compatible or uniformly dispersed in the cellulose ester, the film can be stretched at a temperature in the range of from the glass transition temperature (−20° C.) to the fluidizing temperature. The glass transition temperature of the film can be measured by a known method.

The film constituting material can be stretched in a molten state or diluted state by the solvent for forming the film, and the birefringence of the film can be controlled by stretching within a temperature range of from a temperature lower than that of fluid state where the shape of film is not maintained to a temperature not less than the glass transition temperature (−20° C.).

When the needle-shaped birefringent particles are not homogeneously dispersed in the cellulose ester, the birefringence can be controlled by stretching, when at least one of the following regions satisfy the above mentioned stretching condition: (i) a region of continuous phase of the cellulose ester where an additive is contained; and (ii) a region where the needle-shaped birefringent particles are existing. The above-described conditions are preferable for obtaining the transparent film and controlling the birefringence.

For increasing the contrast of the liquid crystal display of the present invention by preventing the light leaking at 45° in the oblique direction, it is necessary that the retarding value R₀(a) is within the range of 105 nm≦R₀(a)≦350 nm, N_{z} is 0.221 N_{z}<0.7 and preferably Rₜₕ is −30 nm≦Rₜₕ≦+20 nm. It is not fully easy to improve the viewing angle property of the IPS mode liquid crystal display without satisfying the above described conditions.

(Control of Three Dimensional Refractive Index)

It is characteristic in the present invention that Optical Film A satisfying the relation of nₓ(a)>n_{z}(a)>n_{y} is obtained by stretching the film in y direction in the production process.

In Optical Film A, when the directions in the film plane is defined as x and y (x and y are orthogonal to each other) and the direction of the thickness is defined as z, and the refractive indexes each corresponding to the directions x, y, and z are defined as nₓ(a), n_{y}(a) and n_{z}, respectively, it is important in the present invention that the refractive indexes are three dimensionally controlled.

In the present invention, the resin showing the positive birefringence along the stretching direction and the needle-shaped birefringent particle are employed for controlling the three dimensional refractive indexes, the forgoing nₓ, n_{y} and n_{z}. In such the case, the tenter is preferably applied by which the film can be continuously stretched in fixed width while making the film surface highly flat.

When a film containing no needle-shaped particles having negative birefringence is produced by the method of the present invention, the relation will be n_{y}(p)>nₓ(p)>n_{z}(p) is made, where y is the stretched direction.

In the above, n_{y}(p), nₓ(p) and n_{z}(p) each represent the refractive indexs along the stretching direction y, in the direction orthogonal y in the film plane x, and the thickness direction z, respectively. Typical examples of such a film include KC8UCR-3 manufactured by Konica Minolta Opto, Inc.

On the occasion of producing Optical Film A, negative birefringence appears along the stretching direction by the presence of the needle-shaped birefringent particles in the resin film. In this case, applicable is a material (needle-shaped birefringent particle) showing the negative uniaxial refractivity satisfying the relation of n_{y}(ma)<nₓ(ma)=n_{z}(ma) or that showing weak biaxial refractivity satisfying the relation of n_{y}(ma)<(nₓ(ma)≈n_{z}(ma)).

The n_{y}(ma), nₓ(ma) and n_{z}(ma) each represent the refractive indexes of the needle-shaped birefringent particle appeared by the orientation caused by the stretching in the stretching direction y, in the direction orthogonal to the stretching direction in the film plane x and in the thickness direction z, respectively, when the stretching direction is defined as y.

The above-described n_{y}(ma), nₓ(ma) and n_{z}(ma) represent the refractive indexes of the needle-shaped birefringent particle, which does not contain the refractive indexes originated from the cellulose ester film itself, although the needle-shaped birefringent particles are mixed with the cellulose ester, solution cast and stretched to form Optical Film A.

In this case, it is necessary for satisfying the relation of nₓ(a)>n_{z}(a)>n_{y}(a) that the optical contribution of the needle-shaped birefringent particle to the birefringence of the film is larger than the optical contribution of the cellulose ester containing no needle-shaped birefringent particle to the birefringence of the film.

It is preferable in the present invention to use Optical Film A to the polarization plate protective film in which cellulose ester is used for the resin of the film and the ratio of [(Weight of resin of film containing no needle-shaped birefringent particle)/(Weight of needle-shaped birefringent particle) is preferably more than 1, more preferably more than 2 and further more preferably more than 3.

The preferable stretching ratio of Optical Film A of the present invention is 1.01 to 3.00 in one direction and 1.00 to 2.50 in another direction; more preferably 1.01 to 3.00 in one direction and 1.00 to 2.00 in another direction; and further more preferably 1.01 to 3.00 in one direction and 1.01 or more but less than 1.50 in another direction; still more preferably 1.01 to 3.00 in one direction and 1.01 or more but less than 1.25 in another direction; and still further more preferably 1.01 to 2.50 in one direction and 1.01 or more but less than 1.25 in another direction. Optical Film A of the present invention having the retardation value and high flatness can be obtained by the above-described stretching. Holding of width of the film or the stretching in the transverse direction is preferably carried out by the tenter which may be a pin tenter of a clip tenter.

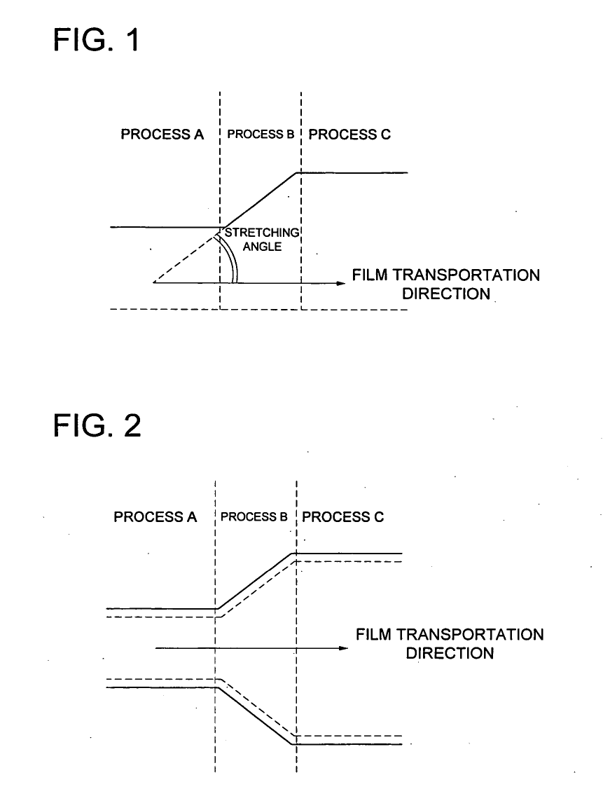

An example of the stretching process (also referred to as a tenter process) for producing the optical compensation film relating to the present invention is described below referring FIGS. 1 and 2.

In FIG. 2, the film transported from the film transporting process D0, not shown in the drawing, is held in Process A and stretched in the transverse direction (the direction orthogonal the transportation direction of the film) in the angle as shown in FIG. 1 in next Process B, and the stretching is finished and the film is transported in Process C while being held.

A slitter for slitting off the both side edge portions of the film is preferably provided at a position in the course of from peeling of the film to the entrance of Process B and/or just before Process C. It is specifically preferable to provide the slitter for slitting off the both side edge portions of the film at just before Process A. The effect of improving the distribution of the optical slow axis, hereinafter referred to as orientation angle distribution, in the transverse direction in the film from which the both side edge portions are silted off is superior to that in the film without slitting when the same stretching is applied in the transverse direction.

It is supposed that such the effect is obtained by preventing the undesired stretching in the longitudinal direction between the peeling point and the Process B where the film still contains a relatively large amount of the residual solvent.

It is preferable to intentionally provide a zone different in the temperature in the tenter process for improving the orientation angle distribution. A neutral zone is preferably provided between the zones of which temperature is different from each other in the temperature for preventing the interference between the zones.

The stretching operation may be carried out stepwise in plural steps, and preferably carried out is biaxial stretching in the longitudinal direction and in the transverse direction. When the biaxial stretching is carried out, the stretching may be conducted simultaneously or stepwise. In the case of the stepwise stretching, it is possible, for example, that the stretching steps each different in the direction can be successively carried out or the stretching in the same direction is divided into plural steps and a stretching step in the different direction is added to certain step of them. For example, the following stretching steps can be applied.

(a) Stretching in longitudinal direction—Stretching in transverse direction—Stretching in longitudinal direction—Stretching in transverse direction

(b) Stretching in transverse direction—Stretching in transverse direction—Stretching in longitudinal direction—Stretching in longitudinal direction

The simultaneous biaxial stretching includes a case in which the film is stretched in a direction while shrunking in another direction by reducing the tension.

Though the term of “stretching direction” usually means the direction in which the stretching stress is directly applied on the occasion of the stretching operation, it is also used for meaning the direction finally stretched in a larger stretching ratio, which usually becomes the direction of the slow axis. Specifically, when simply described as “stretching direction” in the description relating to the dimensional variation ratio, the “stretching direction” is mainly used in the later meaning.

In order to improve the dimensional stability which is evaluated by keeping the film under the condition of 80° C. and 90% RH, the stretching operation is preferably carried out by heating under the presence of the residual solvent.

It is well known that the distribution of orientation angle becomes wider when the film is stretched in the transverse direction. There is a relative relation among the temperatures in Processes A, B and C for carrying out the stretching in the transverse direction while maintaining the ratio of Rₜₕ and Rₒ at a certain value. A relation of Ta≦Tb−10 is preferable when the temperatures in Processes A, B and C are each represented by Ta ° C., Tb ° C. and Tc ° C., respectively. A relation of Tc≦Tb is also preferable. It is more preferable that the relations of Ta≦Tb−10 and Tc≦Tb are simultaneously satisfied.

The temperature raising rate of the film in Process B is preferably in the range of 0.5 to 10° C./second for improving the orientation angle distribution.

The stretching in Process B is preferably carried out for a shortened duration in order to decrease the dimensional variation under the condition of 80° C. and 90% RH. However, a range of time at least necessary for the stretching is decided from the viewpoint of the uniformity of the film. Concretely, the stretching time is preferably within the range of 1 to 10 seconds, and more preferably 4 to 10 seconds. The temperature in Process B is preferably 40 to 180° C., and more preferably 100 to 160° C.

In the above tenter process, the heat treatment may be carried out under a constant heat conductivity or under a varied heat conductivity. The heat conductivity is preferably in the range of 41.9×10³ to 419×10³ J/m²hr, more preferably in the range of 41.9×10³ to 209.5×10³ J/m²hr, and most preferably in the range of 41.9×10³ to 126×10³ J/m²hr.

For improving the dimensional stability evaluated at 80° C. and 90% RH, the stretching speed in the transverse direction may be constant or varied. The stretching speed is preferably 50 to 500%/min, more preferably 100 to 400%/min, and most preferably 200 to 300%/min.

In the tenter process, the temperature distribution in the transverse direction in the atmosphere is preferably small in order to increase the uniformity of the film. The temperature distribution in the transverse direction in the tenter process is preferably within ±5° C., more preferably within ±2° C., and most preferably within ±1° C. It can be expected that the temperature distribution in the transverse direction of the film is reduced by decreasing the above temperature distribution.

The film is preferably eased in the transverse direction in Process C for preventing the dimensional variation. Concretely, the width of the film is preferably controlled so that the width is decreased to 95 to 99%.

A latter drying process, hereinafter referred to as Process D1, is preferably provided after the tenter treatment. In the latter drying process, drying is preferably carried out at a temperature in the range of 50 to 140° C., more preferably 80 to 140° C., and most preferably 110 to 130° C.

A reduced atmosphere temperature distribution in the transverse direction of the film is preferable for raising the uniformity of the film. The temperature distribution is preferably within ±5° C., more preferably within ±2° C., and most preferably within ±1° C.

The tension for transporting the film is preferably 120 to 200 N/m, more preferably 140 to 200 N/m, and most preferably 140 to 160 N/m, although the transportation depends on the physical properties of the dope and the residual solvent amount at the peeling point and in Process D0.

A tension cutting roller is preferably provided for preventing the expansion of the film in the transportation direction in Process D1. The side edge portion of the film is preferably cut off by a slitter provided after the drying and before the winding for forming a good shaped film roll.

When Optical Film A is in a form of long length roll, the slow axis of the optical film is preferably met with the transportation direction of the film.

The composition of Optical Film A of the present invention, namely the film composition containing at least one kind of needle-shaped birefringent particle showing negative birefringence along the stretching direction and at least one kind of resin polymer showing positive birefringence along the stretching direction, has a characteristic that the slow axis can be formed in the film forming direction or the transportation direction of the film by continuously stretching the film in the transverse direction.

When the slow axis of the Optical Film A to be applied as the polarizing plate protective film is in the longitudinal direction, the PVA polarizing element and Optical Film A can be directly pasted with each other since the absorbing axis of the long roll PVA polarizing element is also in the longitudinal direction.

(g) Winding Process:

In this process, the web after drying is wound up. The film having good dimensional stability can be obtained when the amount of residual solvent at the end of the drying process is not more than 2% by weight, and preferably not more than 0.4% by weight. A usually used winder may be applied for the winding. The method for winding include a method for controlling the tension such as a constant torque method, a constant tension method, taper tension method, and a program tension control method in which the interior stress is constantly held, and these methods may be suitably selected. Such the situation is preferable for the production efficiency of the polarizing plate.

The residual amount of the solvent can be expressed by the above Equation (1).

The thickness of the final cellulose ester film is preferably within the range of from 10 to 120 μm, more preferably from 30 to 100 μm, and specifically preferably from 35 to 85 μm, although the thickness may be varied according to the purpose of the use. When the film is too thin, the strength necessary for the polarizing plate protective film may not be obtained. When the thickness is too thick, the advantage of the thin film is lost. The layer thickness is suitably controlled to desired thickness by controlling the dope concentration, the transporting amount of the solution through the pump, the slit space of the mouth metal of the die, an extruding pressure through the die or the speed of the metal support. The thickness is preferably controlled using a layer thickness detecting means for feedbacking the programmed data to the above various devices.

In the course of from just after the casting to the drying in the solution-casting method, the atmosphere of the production equipment is air, and an inactive gas atmosphere such as nitrogen gas and carbon dioxide gas is also applicable. Danger of exceeding the explosion limit of the evaporated solvent in the drying atmosphere should be definitely considered.

Next, Optical Film B preferable in the present invention will be described below.

Optical Film B preferably employed in the present invention is an optical film to be provided onto the liquid crystal displaying cell side of a polarizing plate to be arranged on the surface of the IPS mode crystal cell opposite to the surface on which the optical film described in any one of above Items (1) through (3) is arranged. Film B is characterized in that the retardation values Rₒ(b) and Rₜₕ(b) expressed by the following Equations (iv) and (v) of the film satisfy conditions of −15 nm≦Rₒ(b)≦15 nm and −15 nm≦Rₜₕ(b)≦15 nm.
Rₒ(b)=(nₓ(b)−n_{y}(b))×d Equation (iv)
Rₜₕ(b)={(nₓ(b)+n_{y}(b))/2−n_{z}(b)}×d Equation (v)

In the above, nₓ(b) is the refractive index in the slow axis direction in the film plane, n_{y}(b) is the refractive index in the direction orthogonal to the slow axis in the film plane, n_{z}(b) is the refractive index in the thickness direction of film and d is the film thickness in nm of Optical Film B.

Optical Film B satisfying the above conditions of the retardation values can be produced by the method described in JP-A No. 2003-12859. In concrete, it is preferable to add the polymer described in JP-A No. 2003-12859, paragraphs [0032] to [0049] to cellulose ester film, and the retardation value can be controlled by the kind and the amount of the polymer.

Optical Film B preferably contains the following polymer for satisfying the above conditions of the retardation values.

A polymer obtained by polymerizing an ethylenically unsaturated monomer, an acrylic polymer, an acrylic polymer having an aromatic ring on a side chain thereof and an acrylic polymer having a cyclohexyl group on a side chain thereof are preferably usable for Optical Film B.

The weight average molecular weight of the polymer is preferably 500 to 30,000, and specifically preferably 500 to 10,000 which has good compatibility with the cellulose ester and does not cause evaporation and volatilization in the film forming process. Further, the acrylic polymer and the acrylic polymer having the aromatic ring or cyclohexyl ring on the side chain thereof and preferably each having a weight average molecular weight of 500 to 5,000 have superior properties as the polarizing plate protective film since that is superior in the transparency and extremely low moisture permeability in addition to the above-described characteristics.

The polymer to be used in the present invention is considered as a substance between an oligomer and a low molecular weight polymer when the weight average molecular weight of the polymer is 500 or more but less than 10,000. For polymerizing such the polymer, a method by which the molecular weight is not made excessively large and the molecular weight can be made as even as possible is preferably applied because the molecular weight is difficult to control in a usual polymerization method. Such the method includes: (i) a method using a peroxide polymerization initiator such as cumene peroxide and t-butyl hydroperoxide; (ii) a method using a larger amount of polymerization initiator than that in the usual polymerization method; (iii) a method using a chain-transfer agent such as a mercapto compound and carbon tetrachloride additionally to the polymerization initiator; (iv) a method using a polymerization terminator such as benzoquinone and dinitrobenzene in addition to the polymerization initiator; and (v) a method described in JP-A No. 2000-128911 or 2000-344823 in which bulk polymerization is carried out using a polymerization catalyst of (a) a compound having one thiol group and a secondary hydroxyl group, or (b) a combination of the compound described in above (a) and an organic metal compound. Any of the above methods can be preferably applied in the present invention, and the method described in the above patent documents is specifically preferable.

The monomers for the monomer unit constituting the polymer useful in the present invention are described below, but the monomer is not limited thereto.

Examples of the ethylenically unsaturated monomer unit constituting the polymer obtained by polymerization thereof include: vinyl esters such as vinyl acetate, vinyl propionate, vinyl butyrate, vinyl valerianate, vinyl pivalate, vinyl caproate, vinyl caprate, vinyl laurate, vinyl myristate, vinyl parmitate, vinyl stearate, vinyl cyclohexanecarbonate, vinyl octylate, vinyl methacrylate, vinyl crotonate, vinyl sorbate, vinyl benzoate and vinyl cinnamate; acrylate esters such as methyl acrylate, ethylacrylate, i- or n-propyl acrylate, n-, i-, s- or t-butyl acrylate, n-, i- or s-pentyl acrylate, n- or i-hexyl acrylate, n- or i-heptyl acrylate, n- or i-octyl acrylate, n- or i-octyl acrylate, n- or i-myristyl acrylate, cyclohexyl acrylate, 2-ethylhexyl acrylate, benzyl acrylate, phenetyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, p-hyfroxymethylphenyl acrylate and p-(2-hydroxyethyl)phenyl acrylate; methacrylate esters such as those the same as the above acrylate esters in which acrylate is replaced by methacarylate; and unsaturated acids such as acrylic acid, methacrylic acid, maleic anhydride, crotonic acid and itaconic acid. The polymer constituted by the above-described monomer may be a homopolymer or a copolymer, and a homopolymer of the vinyl ester, a copolymer of vinyl ester, and a copolymer of the vinyl ester and the acrylate ester or the methacrylate ester are preferable.

In the present invention, “an acrylic polymer” (merely referred to as “an acrylic polymer”) represents a homopolymer or a copolymer of an alkyl acrylate or methacrylate having no aromatic group or no cyclohexyl group. Alternatively, “an acrylic polymer having an aromatic group on the side chain” represents an acrylic polymer containing an acrylate monomer unit or a methacrylate monomer unit which always have an aromatic ring. Also, “an acrylic polymer having a cyclohexyl group on the side chain” represents an acrylic polymer containing acrylate or methacrylate monomer unit which always have a cyclohexyl group.

The acrylic polymer is a homopolymer or a copolymer of the foregoing monomers and preferably contains not less than 30% by weight of methyl acrylate monomer or not less than 40% by weight of methyl methacrylate. Specifically, a homopolymer of methyl acrylate or methyl methacrylate is preferable.

Examples of the acrylate or methacrylate monomer include phenyl acrylate, phenyl methacrylate, 2- or 4-chlorophenyl acrylate, 2- or 4-chlorophenyl methacrylate, 2-, 3- or 4-ethoxycarbonylphenyl acrylate, 2-,3- or 4-ethoxycarbonylphenyl methacrylate, o-, m- or p-tolyl acrylate, o-, m- or p-tolyl methacrylate, benzyl acrylate, benzyl methacrylate, phenethyl acrylate, phenethyl methacrylate and 2-naphthyl acrylate, and benzyl acrylate, benzyl methacrylate, phenethyl acrylate and phenethyl methacrylate can be preferably used.

Among the acrylic polymers having the aromatic group on the side chain thereof, one having 20 to 40% by weight of the acrylate or methacrylate monomer having the aromatic group and 50 to 80% by weight of methyl acrylate or methyl methacrylate monomer is preferred. Such the polymer is preferably contains 2 to 20% by weight of acrylate or methacrylate monomer each having a hydroxyl group.

Examples of the acrylate monomer having the cyclohexyl group include cyclohexyl acrylate, cyclohexyl methacrylate, 4-methylcyclohexyl acrylate, 4-methylcyclohexyl methacrylate, 4-ethylcyclohexyl acrylate and 4-ethylcyclohexyl methacrylate, and cyclohexyl acrylate and cyclohexyl methacrylate are preferably can be used.

Among the acrylic polymers having the cyclohexyl group on the side chain thereof, one having 20 to 40% by weight of the acrylate or methacrylate monomer having the cyclohexyl group is preferred. Such the polymer preferably contains 2 to 20% by weight of acrylate or methacrylate monomer each having a hydroxyl group.

The above-described polymer obtained by polymerizing the ethylenically unsaturated monomer, acrylic monomer, acrylic monomer having the aromatic group on the side chain thereof and the acrylic polymer having the cyclohexyl group on the side chain thereof are all superior in: (i) compatibility with the cellulose ester, (ii) production efficiency without evaporation and volatilization, (iii) durability as the polarization protective film, (iv) low moisture permeability, and (v) dimension stability.

The acrylate or methacrylate monomer having a hydroxyl group on the side chain thereof is a monomer to be used as a constituting unit of copolymer, not for homopolymer. In this case, the acrylate or methacrylate monomer unit having the hydroxyl group is preferably contained in the acrylic polymer in a ratio of 2 to 20% by weight.

In the present invention, the polymer having the hydroxyl group on the side chain thereof is also preferably usable. As the monomer unit having the hydroxyl group is preferably an acrylate and a methacrylate similar to the above-mentioned. Examples of such the monomer unit include 2-hydroxyethyl acrylate, 2-hydroxypropyl acrylate, 3-hydroxypropyl acrylate, 4-hydroxybutyl acrylate, 2-hydroxybutyl acrylate, p-hydroxymethylphenyl acrylate, p-(2-hydroxyethyl)phenyl acrylate and those described in the above in which the acrylate is replaced by methacrylate, and 2-hydroxyethyl acrylate and 2-hydroxyethyl methacrylate are preferable. The acrylate or methacrylate monomer unit having the hydroxyl group is preferably contained in the polymer in a ratio of from 2 to 20%, and more preferably from 2 to 10%, by weight.

The forgoing polymer containing the monomer unit having a hydroxyl group in a ratio of 2 to 20% by weight is superior in compatibility with cellulose ester, retention of additives, dimensional stability, low moisture permeability, and adhesiveness with the polarizing element, whereby the durability of the polarizing plate is increased.

In the present invention, it is preferable that the polymer has the hydroxyl group at least one end of the main chain. The method for giving the hydroxyl group at the end of the main chain is not specifically limited as long as the hydroxyl group is bonded at the end of the main chain. Such the polymer can be obtained by a method using a radical polymerization initiator having a hydroxyl group such as azo-bis(2-hydroxyethyl butyrate), a method using a chain-transfer agent having a hydroxyl group such as 2-mercaptoethanol, a method using a polymerization terminator having a hydroxyl group, a method for giving a hydroxyl group at the end of main chain by living ion polymerization, or a method such as that described in JP-A No. 2000-128911 or 2000-344823 in which a compound having one thiol group and a secondary hydroxyl group or a polymerization catalyst composed of such the compound and an organic metal compound is employed for performing bulk polymerization, and the method described in the above patent documents is preferable. Polymers produced by the method relating to the description of the above patent documents are put on the market by Souken Kagaku Co., Ltd., under the commercial name of Actoflow Series, which are preferably usable.

In the present invention, the polymer having the hydroxyl group at the end of the main chain and/or the side chain exhibit effects of notably improving compatibility and transparency of the polymer.

Such the polymers are preferably contained in Optical Film B in a ratio of 1 to 35% by weight, and specifically 3 to 25% by weight for controlling the retardation value.

Optical Film B can be produced by a known cellulose ester film producing method. Specifically, the method disclosed in JP-A No. 2002-249599 is applicable and the combination of the foregoing additives is preferable.

Properties of Optical Films A and B are described below.

(Transmittance of Optical Film)

The optical film for the material of the LCD display preferably has high transmittance and high UV absorbance. The transmittance at 500 nm of the optical film produced by using the foregoing additives is preferably 85 to 100%, more preferably 90 to 100%, and most preferably 92 to 100%. The transmittance at 400 nm is preferably 40 to 100%, more preferably 50 to 100%, and most preferably 60 to 100%. The transmittance at 380 nm is preferably 0 to 10%, more preferably 0 to 5%, and most preferably 0 to 3%.

(Thickness Distribution in the Transverse Direction of Optical Film)

The thickness distribution R in percent of the optical film in the transverse direction is preferably controlled in the stretching process to a value of 0%≦R %≦8%, more preferably 0%≦R %≦5%, and specifically preferably 0%≦R %≦4%.

(Haze Value of Optical Film)

It is supposed that one of the reasons of increase in haze of the optical film stretched in the transverse direction is the unintended stretching in the longitudinal direction of the optical film. When the optical film is stretched under a condition in which the haze value is controlled at a low level, the uniformity of in-plane retardation values and a retardation value in the thickness direction of the optical film is also improved.

It is preferable that, in the stretching process, the optical film is stretched under a condition in which the haze value of the stretched film is suppressed in a certain range. The haze value of the optical film is preferably not more than 2%, more preferably not more than 1.5%, and most preferably not more that 1%.

(Elastic Modulus of Optical Film)

In the stretching process of the optical film in the transverse direction, it is preferable that the stretching is carried out under a condition so that the tensile strength of the film after stretching is controlled within a certain range.

When the optical film is stretched in the transverse direction, it is preferable that the stretching is carried out under a condition so that the elastic modulus of the optical film after stretching is controlled within a certain range. The elastic modulus in the transverse direction (TD) and that in the longitudinal direction (MD) may be the same or different. Occurrence of unintended stretching in the longitudinal direction of the optical film stretched in the transverse direction may vary the elastic modulus of the optical film after the stretching process. When the optical film is stretched under a condition in which the elastic modulus is controlled within a certain range, the uniformity of in-plane retardation values and a retardation value in the thickness direction of the optical film is also improved.

In concrete, the elastic modulus is preferably within the range of 1.5 to 5 GPa, more preferably 1.8 to 4 GPa, and specifically preferably 1.9 to 3 GPa.

Occurrence of unintended expansion in the longitudinal direction in the optical film stretched in the transverse direction may cause variation in the breaking point stress of the optical film after the stretching process. When the optical film is stretched under a condition in which the breaking point stress is controlled within a certain range, the uniformity of in-plane retardation values and a retardation value in the thickness direction of the film is also improved, and further, the Rₜₕ/Rₒ value is suppressed at a low level. The breaking point stress in the transverse direction (TD) and the in the longitudinal direction (MD) may be the same or different.

In concrete, the breaking point stress is preferably controlled within the range of 50 to 200 MPa, more preferably 70 to 150 MPa, and most preferably 80 to 100 MPa.

Occurrence of unintended expansion in the longitudinal direction in the film stretched in the transverse direction may vary the breaking point elongation of the film after the stretching process. When the optical film is stretched under a condition in which the breaking point elongation is controlled within a certain range, the uniformity of in-plane retardation values and a retardation value in the thickness direction of the film is also improved, and further, the Rₜₕ/Rₒ value is suppressed at a low level. The breaking point elongation in the transverse direction (TD) and the in the longitudinal direction (MD) may be the same or different.

In concrete, the breaking point elongation at 23° C. and 55% HP is preferably controlled within the range of 20 to 80%, more preferably 30 to 60%, and most preferably 40 to 50%.

Occurrence of unintended expansion in the longitudinal direction in the film stretched in the transverse direction may vary the hygroscopic expansion of the film after the stretching process. When the optical film is stretched under a condition in which the hygroscopic expansion is controlled within a certain range, the uniformity of in-plane retardation values and a retardation value in the thickness direction of the film is also improved, and further, the Rₜₕ/Rₒ value is suppressed at a low level. The hygroscopic expansion in the transverse direction (TD) and the in the longitudinal direction (MD) may be the same or different.

In concrete, the hygroscopic expansion is preferably within the range of −1 to 1%, more preferably −0.5 to 0.5%, and most preferably 0 to 0.2%.

Occurrence of unintended expansion in the longitudinal direction of the optical film stretched in the transverse direction may accelerate formation of luminescent foreign substances. In concrete, the number of luminescent foreign substance is preferably controlled within the range of from 0 to 80/cm², more preferably from 0 to 60/cm², and most preferably from 0 to 30/cm².

When the optical film is used as the polarizing plate protective film, the film is usually subjected to an alkali saponification treatment for improving the adhesiveness with the polarizing element. The film after the saponification treatment is pasted with the polarizing element using an aqueous polyvinyl alcohol solution. However, when the contact angle of water on the optical film after the saponification treatment is high, the optical film cannot be pasted with the polarizing element using the polyvinyl alcohol, which means that the film is not suitable for the polarizing plate protective film.

The contact angle of water on the optical film after saponification treatment is preferably 0 to 60°, more preferably 5 to 55°, and most preferably 10 to 30°.

(Center-Line Average Roughness Ra of Optical Film)

When the optical film is employed for the material of the LCD, high flatness is required for reducing the leakage of light. The center-line average roughness Ra is a value defined in JIS B 0601, and is measured by a method such as a stylus method or by an optical method.

The center-line average-roughness Ra of the optical film of the present invention is preferably not more than 20 nm, more preferably not more than 10 nm, and specifically preferably not more than 4 nm.

Outline of the measuring methods of the values relating to the present invention and the measuring methods applied in the later-described examples will be described below.

(Amount of Poor Solvent in Residual Solvent)

The residual solvent was captured under vacuum from a sample and each component of the residual solvent was analyzed by gas chromatography.

(Elastic Modulus, Breaking Point Elongation and Breaking Point Stress of Optical Film)

The film containing optional residual solvent was cut into a piece of 10 mm×130 mm and subjected to a tensile test in a methyl chloride atmosphere under the condition of a chuck distance of 100 mm and a pulling rate of 100 mm/minute.

(Measurement of Refractive Indexes in Slow Axis Direction, Fast Axis Direction, Thickness Direction and Direction of Slow Axis)

The wavelength dispersion was measured at 23° C. under 55% RH by an automatic birefringence analyzer KOBRA-21ADH, manufactured by Oji Scientific Instruments and the retardation values and three dimensional refractive indexes nₓ(a), n_{y}(a), n_{z}(a), nₓ(b), n_{y}(b) and n_{z}(b) were determined using the average refractive index of the sample measured by an Abbe refractometer 1 T for the retardation measurement carried out at a wavelength of 550 nm.

(Tear Strength of Dried Film)

The film was conditioned for 4 hours in a chamber kept at a temperature of 23° C. and a relative humidity of 55%, and cut into a sample having a width of 50 mm and a length of 64 mm, and the tear strength of the sample was measured according to ISO 6383/2-1983.

(Dimensional Variation)

The film was kept for 4 hours in a chamber conditioned at a temperature of 23° C. and a relative humidity of 55%, and marked by a cutter at a distance of about 10 cm in the transverse and longitudinal directions, and the distance L₁ was measured. After that, the film was stood for 24 hours in a chamber conditioned at a temperature of 60° C. and a relative humidity of 90% and then conditioned again for 4 hours in the chamber conditioned at a temperature of 23° C. and a relative humidity of 55% and the distance between the marks L₂ was measured. The dimensional variation was evaluated according to the following Equation.
Dimensional variation (%)={(L₂−L₁)/L₁}×100

(Hygroscopic Expansion)

The film was stood for 4 hours in a chamber conditioned at a temperature of 23° C. and a relative humidity of 55%, and marked by a cutter at a distance of about 20 cm in the transverse and longitudinal directions, and the distance L₃ was measured. After that, the film was stood for 24 hours in a chamber conditioned at a temperature of 60° C. and a relative humidity of 90%. The film was taken out from the chamber and the distance of the marks L₄ was measured within 2 minutes after taking out. The hygroscopic expansion was evaluated according to the following Equation.
Hygroscopic expansion (%)={(L₄−L₃)/L₃}×100

(Thickness Distribution)

The film was stood for 4 hours in a chamber conditioned at a temperature of 23° C. and a relative humidity of 55%. After that, the film thickness was measure at every 10 cm in the transverse direction. The distribution of the thickness R (%) was calculated from the measured data by the following Equation.
R (%)=(Rₘₐₓ−Rₘᵢₙ)×100/Rₐᵥₑ

In the above, Rₘₐₓ is the maximum layer thickness, Rₘᵢₙ is the minimum layer thickness and Rₐᵥₑ is an average layer thickness.

(Haze Value)

The haze was measured as an indicator of the clarity using a haze meter 1001DP, manufactured by Nihon Denshoku Kogyo Co, Ltd., according to the method of JIS K-6714.

(Measurement of Transmittance)

The transmittance T of each sample was measured by a spectral photometer U-3400, manufactured by Hitachi Seisakusho Co., Ltd., at every 10 nm in wavelength in the range of 350 to 700 nm, and the transmittances at wavelengths of 380 nm, 400 nm and 500 nm were calculated from the obtained spectral transmittance τ(λ).

(Curling)

The film sample was stood for 3 days under a condition of 25° C. and 55% RH, and then cut into a piece of 50 mm in the transverse direction and 2 mm in the longitudinal direction of the film. Thus prepared film piece was conditioned for 24 hours under a condition of 23±2° C. and 55% RH and the curling value of the piece was measured by using a curvature scale. The measurement of the curling degree was carried out according to JIS K-7619-1988.

The curling value was expressed by 1/R; R is the radius of curvature.

(Luminescent Foreign Substance)

The sample was placed between two polarizing elements arranged in the state of orthogonally crossing to each other (crossed nicols state) and lighted from outside of one of the polarizing element, and the transferred light was observed by a microscope with a magnification of ×30 from the outside of the other polarizing element. The number per 25 mm² of white luminescent foreign matter was counted. The measurement was carried out at 10 positions and the number/cm² was determined from the total number per 250 mm². In the present invention, the size of the luminescent foreign substance was 5 to 50 μm² and one having a size larger than that was not counted.

(Contact Angle of Water on the Film after Saponification Treatment)

The sample was treated with 2.5N NaOH solution for 2.5 minutes at 50° C. and washed for 2.5 minutes with purified water. The treated sample was conditioned for 24 hours at 23° C. under 55% RH. The contact angle was measured by a contact angle meter CA-D manufactured by Kyowa Kaimen Kagaku Co., Ltd.

(Center-Line Average Roughness Ra)

The center-line average roughness Ra was measured by a non-contact surface profiler WYKO NT-2000 manufactured by Veeco Instruments.

(Image Clcarity)

The clarity of image is defined by JIS K-7105. The clarity is preferably not less than 90%, more preferably not less than 95%, and further preferably not less than 99%, when the measurement was carried out using a slit of 1 mm.

(Measurement of Water Absorption)

The samples was cut into a size of 10 cm×10 cm and immersed in water for 24 hours at 23° C. and then taken out from the water. Just after taking out, water adhering no the sample was wiped off by filter paper and the weight W₁ of the samples was measured. After that, the film was conditioned for 24 hours in an atmosphere of 23° C. and 55% RH, and the weighed. The weight of the sample was referred to as W₀. The water absorption of the film immersed for 24 hours in water at 23° C. was calculated by the following Equation.
Water absorption (%)={(W₁−W₀)/W₀}×100

(Measuring Method of Moisture Content)

The samples was cut into a size of 10 cm×10 cm and conditioned in the atmosphere of 23° C. and 80% RH for 48 hours and weighed; the weight was referred to as W₃. Then the film was dried for 45 minutes at 120° C. and weighed; the weight was referred to as W₂. The moisture content at 23° C. and 80% RH was calculated by the following equation.
Moisture content (%)={(W₃−W₂)/W₂}×100

(Method for Measurement of Moisture Permeability)

The moisture permeability was defined by a value measured by the method described in JIS Z 0208. The moisture permeability of the optical film of the present invention is preferably from 10 to 250 g/m²·24 hours, more preferably from 20 to 200 g/m²·24 hours, and most preferably from 50 to 180 g/m²·24 hours, under a condition of 25° C. and 90% RH.

[Polarizing Plate]

The polarizing plate and the display using the plate will be described below.

The polarizing plate can be produced by a usual method. It is preferable that the back surface of the optical film of the present invention is subjected to the alkali saponification treatment and pasted with a surface of a polarizing element using an aqueous solution of completely saponified polyvinyl alcohol. The polarizing element is prepared by immersing a polyvinyl alcohol film in an iodine solution, followed by stretchingthe film. On the other surface of the polarizing element, the optical film of the present invention may be provided or another polarizing plate protective film may be provided. As the polarizing plate protective film other than the optical film of the present invention, cellulose ester film available on the market can be employed. For example, cellulose ester film available on the market such as KC8UX2M, KC4UX, KC5UX, KC4UY, KC8UY, KC12UR, KC8UCR-3, KC8UR-4, KC8UY-HA and KC8UX-RHA, each manufactured by Konica Minolta Opto, Inc., are preferably used. It is also preferable to use an optical compensation film serving also as a polarizing plate protective film having an optical anisotropic layer formed by orientating a liquid crystal compound such as a discotic liquid crystal, a rod-shaped liquid crystal and a cholesteric liquid crystal. For example, the optical anisotropic layer can be formed by the method described in JP-A No. 2003-98348. The polarizing plate superior in the flatness and having a stable viewing angle enlarging effect can be obtained by the use of such the film in combination with the optical film of the present invention. Moreover; a film of a cyclic olefin resin, an acryl resin, a polyester resin or a polycarbonate resin may be used as the polarizing plate protective film on the other surface of the polarizing plate. In such the case, the film is preferably pasted with the polarizing plate through a suitable adhering treatment because such the film shows low suitability for saponification treatment.

A polarizing plate is constituted by laminating Optical Film A of the present invention as a protective film on at least one surface of a polarizing element. In this case, the optical film is preferably arranged so that the slow axis of Optical Film A is substantially parallel or substantially orthogonal to the absorption axis of the polarizing element.

Optical Film B of the present invention is preferably used as a polarizing plate protective film of a polarizing plate which is provided on the surface of an IPS mode liquid crystal cell reverse to the surface on which a polarizing plate having Optical Film A is provided. Optical Film B is preferably provided on the surface of the polarizing plate closer to the IPS mode liquid crystal cell.

The polarizing element principally constituting the polarizing plate is an element through which light polarized in a certain direction can only be passed. Typical polarization film known at present is a polyvinyl alcohol polarizing film which includes a polyvinyl alcohol film dyed with iodine or with a dichromic dye. As the polarization film, a film made from an aqueous solution of polyvinyl alcohol is employed, which is dyed before or after uniaxial stretching and preferably treated for giving durability with a boron compound. The thickness of the polarization film is preferably 5 to 40 μm, more preferably 5 to 30 μm, and specifically preferably 5 to 20 μm. The polarizing plate is prepared by pasting one side of the optical film of the present invention onto the polarization film (element). They are preferably pasted by an aqueous adhesive mainly composed of completely saponified polyvinyl alcohol. In the case of the resin film other than the cellulose ester film, having low suitability for saponification, the film can be pasted to the polarizing film (element) through a suitable adhesive treatment.

The polarizing element is stretched in one direction, usually in the longitudinal direction. Therefore, when a polarizing plate is kept under a high temperature and high humidity condition, the polarizing element shrinks in the stretching direction, usually in the longitudinal direction, and expands in the direction orthogonal to the stretching direction, usually in the transverse direction. The expansion and shrinkage of the polarizing plate is larger when the polarizing plate protective film is thinner. Specifically the shrinkage in the longitudinal direction is larger. It is important to inhibit the expansion and shrinkage of the film in the casting direction because the stretching direction of the polarizing element is usually the same as the casting direction (MD direction) of the polarizing plate protective film. The optical film of the present invention is superior in the dimensional stability, accordingly, it is suitably employed as a polarizing plate protective film.

A polarizing plate may be constituted by pasting a polarizing plate protective film on one surface of the polarizing plate and a separable film on the other surface. The polarizing plate protective film and the separable film are employed for protecting the polarizing plate in the course of forwarding and inspection of the product. In this case, the protective film is pasted onto the surface of the polarizing plate opposite to the surface to be pasted with the liquid crystal cell for protecting the surface of the polarizing plate. A separable film is employed for covering the adhesive layer for pasting the polarizing plate to the liquid crystal cell and applied onto the surface of the polarizing plate to be pasted with the liquid crystal cell.

(In-Plane Switching Mode Liquid Crystal Display)

The liquid crystal display having superior visibility and enlarged viewing angle according to the present invention can be produced by incorporation of the polarizing plate of the present invention into an IPS mode liquid crystal display available on the market.

The in-plane switching mode liquid crystal display of the present invention includes a fringe-field switching (FFS) mode liquid crystal display; therefore, the polarizing plate of the present invention can also be incorporated in the FFS mode liquid crystal display and can exhibit the same effect as that in the case of the IPS mode liquid crystal display.

In the liquid crystal display, an upper side polarizing element and a lower side polarizing element are arranged in the upper side and the lower side of the liquid crystal cell. In the present invention, Optical Film A is provided between the liquid crystal cell and the upper side polarizing element or between the liquid crystal cell and the lower side polarizing element. And, preferably, Optical Film B is provided between the liquid crystal cell and the upper side polarizing element or between the liquid crystal cell and the lower side polarizing element, where Optical Film A is not provided.

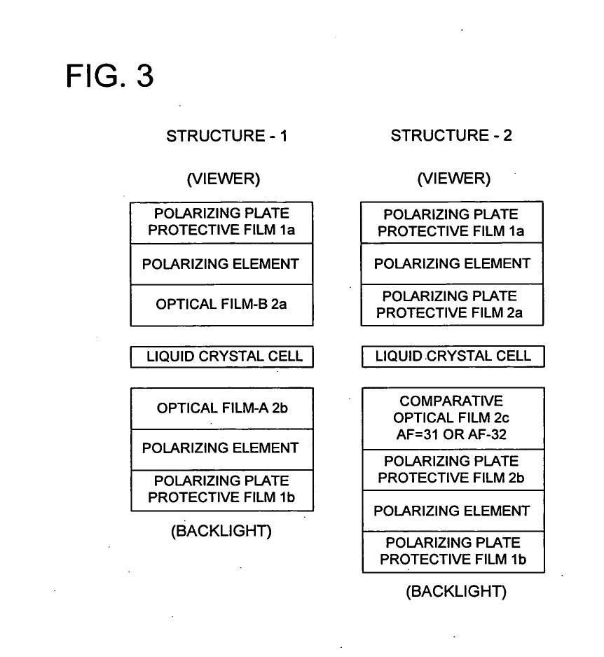

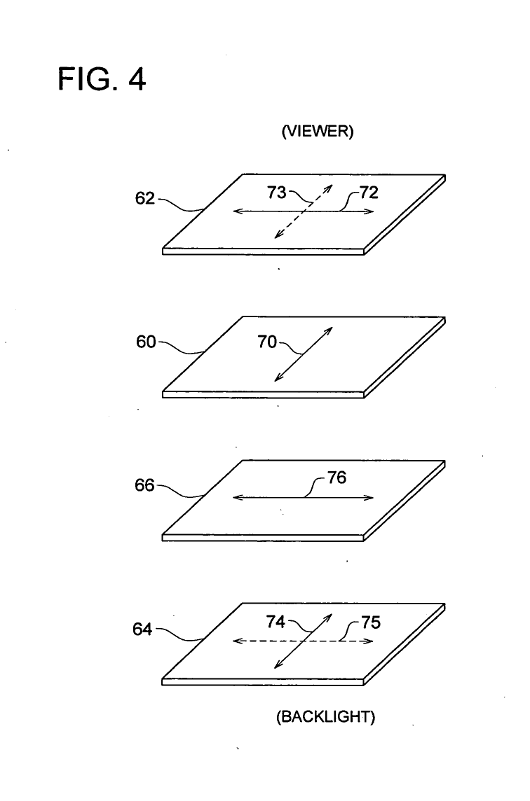

In the present invention, preferable are: (i) Structure 1 shown in FIG. 3; (ii) a structure which is the same as Structure 1 except that the viewer side polarizing plate and the backlight side polarizing plate are reversely arranged at both sides of the liquid crystal cell; (iii) the arrangement of the optical film having the absorption axis in the direction shown in FIG, 4; (iv) the polarizing plate and the liquid crystal cell are examples for the IPS mode liquid crystal display preferable for the present invention. In FIGS. 4 and 5, 60 represents an IPS mode liquid crystal cell; 62 and 64 each represent a polarizing element; 66 represents a optical film of the present invention; 70 represents a rubbing axis (direction) of the liquid crystal cell; 72 and 74 each represent a transmission axis of the polarizing element; 73 and 75 each represent an absorption axis of the polarizing element; and 76 represent a slow axis of the optical film of the present invention.

### EXAMPLES

The present invention is concretely described below referring examples but the present invention is not limited thereto.

### Example 1

### Preparation of Optical Film A of the Present Invention Using Cellulose Ester

The following cellulose esters CE-1 through CE-4 were employed.

CE-1:

Cellulose acetate propionate having an acetyl substitution degree of 1.9, a propionyl substitution degree of 0.8, a molecular weight Mn of 70,000, a molecular weight Mw of 220,000 and a ratio of Mw/Mn of 3.1

CE-2:

Cellulose acetate propionate having an acetyl substitution degree of 1.6, a propionyl substitution degree of 0.9, a molecular weight Mn of 75,000, a molecular weight Mw of 210,000 and a ratio of Mw/Mn of 2.8

CE-3:

Cellulose acetate butyrate having an acetyl substitution degree of 1.9, a butyryl substitution degree of 0.8, a molecular weight Mn of 65,000, a molecular weight Mw of 230,000 and a ratio of Mw/Mn of 2.1

CE-4:

Cellulose acetate having an acetyl substitution degree of 2.92, a molecular weight Mn of 148,000, a molecular weight Mw of 310,000 and a ratio of Mw/Mn of 2.1

As a result of examination on the birefringence of each of CE-1 through CE-4, the cellulose esters entirely exhibited positive birefringence.

(Composition of Dope)

The dope composition of each of the cellulose esters is show below.

| Cellulose ester (CE-1, CE-2 or CE-3) | 100 | parts by weight |
|---|---|---|
| Solvent: Methylene chloride | 380 | parts by weight |
| Ethanol | 70 | parts by weight |
| The following birefringent needle-shaped | Amount described | |
| particle | in Table 1 | |
| Plasticizer: Trimethylolpropane tribenzoate | 10 | parts by weight |
| UV absorbent: | | |
| Ti109 (Ciba Specialty Chemicals Co., Ltd.) | 0.5 | parts by weight |
| Ti171 (Ciba Specialty Chemicals Co., Ltd.) | 0.5 | parts by weight |
| Matting agent: R972V (Nihon Aerogil Co., | 0.2 | parts by weight |
| Ltd.) | | |

(Synthesis of Needle-Shaped Birefringent Particle)

A suspension was prepared by adding 60 parts by weight (20% by weight of water) of methanol and 80 parts by weight (26.7% by weight of water) of strontium hydroxide octahydrate to 300 parts by weight of water. The suspension was stirred by a stirring motor Three-One Motor BLh600, manufactured by Shintou Kagaku Co., Ltd., and further irradiated by ultrasonic wave in a water bath having ultrasonic wave irradiating function of ultrasonic washing machine W-113 Mk-II, manufactured by Honda Denshi Co., Ltd. An ethylene glycol antifreeze solution available on the market, Naibrine® manufactured by Thomas Kagaku Kiki Co., Ltd., was circulated in the water bath by a closed tank type handy cooler TRL-C13, manufactured by Thomas Kagaku Kiki Co., Ltd., for keeping the temperature of the suspension at −10° C.

A mixture of CO₂ gas and nitrogen gas in a ratio of 30:70 was made by a gas mixer and introduced in the suspension in a rate of 200 ml/minute. The gas was introduced until the pH value of the suspension is stabilized at approximately 7 and then the gas was stopped. Besides the suspension, a silane coupling agent solution was prepared by adding acetic acid to 40 parts by weight of water to make the pH of water to about 3.5 and a silane coupling agent (3-glycidoxypropyltrimethoxysilane), was added and stirred for 3 hours.

The amount of the silane coupling agent was 30% by weight of strontium carbonate. Thus prepared silane coupling agent solution was added to the suspension and stirred by a stirring motor for 24 hours for performing the surface treatment. The suspension was filtered with suction through a filter paper having pore size of 0.1 μm for removing unreacted component. After that, the product was put into 600 parts by weight of acetone and washed by stirring for 24 hours, and then filtered again through the filter. The product obtained by the filtration was dried in a vacuum drier. It was confirmed by the observation by a scanning electron microscope (SEM) that the dried crystals are needle-shaped minute crystals of strontium carbonate having an average major axis size of 150 nm and that of minor axis of 18 nm.

The above synthesis was repeated for obtaining the necessary amount of the particle.

(Dispersion of Needle-Shaped Birefringent Particles)

| | | |
|---|---|---|
| Above-prepared particles of SrCO₃ | 40 | parts by weight |
| Methylene chloride | 640 | parts by weight |
| Ethanol | 40 | parts by weight |

The above composition was dispersed by an ultrasonic wave dispersing machine UH-300, manufactured by SMT Co., Ltd., at 10 on the output scale; the dispersion was continued for 5 minutes. After that, the resultant dispersion was further dispersed by Ultra Appex Mill UAM015, manufactured by Kotobuki Kogyo CO., Ltd., under the following conditions.
Amount of dispersion: 400 parts by weight
Dispersion media: 400 parts by weight (filling ratio of 60%) of 50 μm zirconia beads
Circumference speed: 10 m/second

The dispersion was circulated for 5 hours in a rate of 60 ml/minute, and the mill jacket was cooled by cooling water. The dispersion was added to the cellulose ester solution so that the amount in parts by weight of needle-shaped birefringent particle to the cellulose ester was that described in Table 1 and that the composition of the dope was met with the forgoing dope composition. The resultant dope composition was put into a pressure dissolving tank and completely dissolved while heating and stirring, and filtered through Azumi Filter Paper No. 244, manufactured by Azumi Roshi Co., Ltd., to prepare a dope liquid.

The dope liquid was uniformly cast on a stainless steel belt support of 1.8 m width by a belt casting machine. The solvent was evaporated from the cast dope until the residual solvent content decreased to 110%, and the resultant web was peeled off from the stainless steel belt support. On the occasion of the peeling, the web was stretched in the longitudinal-direction (MD) by applying tension so that the expansion ratio became 1.0. After that, the both side edges of the web were each held by tenter and the web was stretched at the temperature and in the stretching ratio each listed in Table 1. The width of the web was held for several seconds and then the tension in the transverse direction was eased and the width holding was released, and then the web was conveyed and dried in a third drying zone held at 125° C. Thus Optical films A1 through A13 were prepared, each of which had a width of 1.5 m, a thickness of 80 μm, a length of 1,000 m and knurling of a width of 1 cm and a height of 8 μm at the edge portion. Moreover, a comparative Optical Film A-14 was prepared in the same manner as above except that the needle-shaped-birefringent particle was not added.

The refractive index along the stretching direction y n_{y}(a), the refractive index in the direction-orthogonal to y in the film plane nₓ(a), the refractive index in the thickness direction of the film n_{z}(a) were measured according to the following procedure. These refractive indexes in each of Optical Films A1 through 13 satisfied the relation of nₓ(a)>n_{z}(a)>n_{y}(a). However, the relation of them in comparative Optical Film A14 was n_{y}(a)>nₓ(a)>n_{z}(a). The values of Rₒ(a), Rₜₕ(a) and N_{z} were determined based on the above-measured refractive indexes and the thickness of the film by the following method and listed in Table 1.

(Measurement of Rₒ(a), Rₜₕ(a) and N_{z})

The films were subjected to measurement of three dimensional refractive index and the wavelength scattering by an automatic birefringence analyzer KOBRA-21ADH, manufactured by Oji Scientific Instruments under a condition of 23° C. and 55% RH. The values of Equations (i), (ii) and (iii) at a wavelength of 550 nm were determined by inputting the average refractive index of the material constituting the film at 550 nm measured by an Abbe refractometer 1 T and the thickness of the film. In the equations, n_{y}(a) is the refractive index along the stretching direction, nₓ(a) is the refractive index in the direction orthogonal to y in the film plane, and n_{z}(a) is the refractive index in the thickness of the film.
Rₒ(a)=(nₓ(a)−n_{y}(a))×d Equation (i)
N_{z}=(nₓ(a)−n_{z}(a))/(nₓ(a)−n_{y}(a)) Equation (ii)
Rₜₕ(a)={(nₓ(a)+n_{y}(a))/2−n_{z}(a)}×d Equation (iii)

(Measurement of Surface Roughness Ra)

The surface roughness of each of five pieces of film was measured by an atomic force microscope SPI 3800N, manufactured by Seiko Instruments, Inc., the measured area was 20 μm×20 μm in each of the pieces. The surface roughness Ra in nanometer was defined by the average value of the measured results. The preferable Ra value is not more than 3 nm in the present invention.

TABLE 1

| | | | Adding | | | | | | | |
|---|---|---|---|---|---|---|---|---|---|---|
| | | | amount of | | | | | | | |
| | | | needle-shaped | | | | | | | |
| Optical | | Needle-shaped | briefringent | Stretching | Stretching | | | | | |
| Film A | Cellulose | briefringent | particle (Parts | temperature | ratio | Ro | Rth | | | |
| No. | ester | particle | by weight) | (° C.) | (Times) | (a) | (a) | Nz | Ra | Remarks |
| 1 | CE-1 | SrCO₃ | 16 | 165 | 1.8 | 220 | −40 | 0.32 | 2.6 | Inventive |
| 2 | CE-1 | SrCO₃ | 15 | 165 | 1.7 | 220 | 0 | 0.50 | 2.7 | Inventive |
| 3 | CE-1 | SrCO₃ | 13 | 165 | 1.8 | 220 | 29 | 0.63 | 2.6 | Inventive |
| 4 | CE-1 | SrCO₃ | 19 | 165 | 1.7 | 270 | −53 | 0.30 | 2.6 | Inventive |
| 5 | CE-1 | SrCO₃ | 16 | 165 | 1.8 | 270 | 0 | 0.50 | 2.5 | Inventive |
| 6 | CE-1 | SrCO₃ | 15 | 165 | 1.9 | 270 | 31 | 0.61 | 2.3 | Inventive |
| 7 | CE-2 | SrCO₃ | 22 | 165 | 1.7 | 330 | −60 | 0.32 | 2.4 | Inventive |
| 8 | CE-3 | SrCO₃ | 20 | 151 | 1.8 | 330 | 0 | 0.50 | 2.6 | Inventive |
| 9 | CE-3 | SrCO₃ | 18 | 153 | 1.9 | 330 | 50 | 0.65 | 2.7 | Inventive |
| 10 | CE-2 | SrCO₃ | 15 | 163 | 1.5 | 181 | −28 | 0.35 | 2.6 | Inventive |
| 11 | CE-2 | SrCO₃ | 14 | 163 | 1.6 | 141 | −35 | 0.25 | 2.6 | Inventive |
| 12 | CE-2 | SrCO₃ | 12 | 163 | 1.6 | 141 | 0 | 0.50 | 2.8 | Inventive |
| 13 | CE-2 | SrCO₃ | 11 | 163 | 1.7 | 145 | 25 | 0.67 | 2.4 | Inventive |
| 14 | CE-1 | — | — | 140 | 1.4 | −50 | 130 | −2.1 | 2.4 | Comparative |

(Preparation of Comparative Optical Film)

(Preparation of Comparative Optical Film AF-31)

A comparative optical film without stretching was prepared by a heat shrinkage method according to the following procedure.

A 25 μm thick acryl adhesive layer was provided on a surface of a long roll heat shrinkable biaxially stretched polypropylene film having: (i) a thickness of 60 μm, (ii) a shrinking stress in the transverse direction orthogonal to the transportation direction of 3.2 N/mm², (iii) a shrinking stress ratio in the transverse direction/transportation direction of 3.8, (iv) a shrinking ratio in the transportation direction of 16%, and (v) a shrinking ratio in the transverse direction of 38%, and the polypropylene film was pasted on both sides of a long roll polycarbonate film having a thickness of 60 μm and a phase difference of about 0. The resultant film was shrunk by heating at 160° C. for shrinking in the transporting direction and transverse direction while transporting by a stretching machine. After that, the shrinkable film was peeled off to obtain a comparative Optical Film AF-31 having a thickness of 65 μm.

Comparative Optical Film AF-31 had a Rₒ value of 186 nm, a Rₜₕ value of −41 nm, a N_{z} value of 0.28 and a surface roughness Ra of 5.9 nm.

(Preparation of Comparative Optical Film AF-32)

Comparative Optical Film AF-32 having a thickness of 65 μm was prepared in the same manner as in Optical Film AF-31 except that the shrinkable film was replaced with a biaxially stretched polypropylene film having a shrinking stress of 1.2 N/mm², a shrinking stress ratio of in the transverse direction to that of in the transportation direction of 2.3, a shrinking ratio in the transportation direction of 11% and a shrinking ratio in the transverse direction of 22%.

Comparative Optical Film AF-32 had a Rₒ value of 131 nm, a Rₜₕ value of −24 nm, a N_{z} value of 0.30 and a surface roughness Ra of 6.1 nm.

(Preparation of Comparative Optical Film AF-33)

Comparative Optical Film AF-33 was prepared by a heat shrinking method according to the following procedure.

A 25 μm acryl adhesive layer was provided on one surface of a long roll heat shrinkable biaxially stretched polypropylene film having: (i) a thickness of 60 μm, (ii) a shrinking stress in the transverse direction orthogonal to the transportation direction of 1.2 N/mm², (iii) a shrinking stress ratio in the transverse direction/transportation direction of 2.3, (iv) a shrinking ratio in the transportation direction of 11%, and (v) a shrinking ratio in the transverse direction of 22%, to form a preparation material. The resultant material was pasted through the adhesive layer on both sides of the foregoing Optical Film A14 having a thickness of 80 μm and shrunk by heating at 160° C. for applying a shrinking treatment to Optical Film A14 in the transportation and transverse directions thereof. After that, the preparation material was peeled off to obtain comparative Optical Film AF-33 having a thickness of 86 μm. The retardation of the film Rₒ and Rₜₕ measured by the foregoing method were −41 nm and 105 nm, respectively.

(Preparation of Comparative Optical Film AF-34)

Comparative Optical Film AF-34 having a thickness of 86 μm was prepared in the same manner as in Optical Film AF-33 except that Optical Film A14 was replaced with the later-mentioned Optical Film BF-3. The retardation of thus obtained optical film was measured by the same method as above. The value of Rₒ(a) and that of Rₜₕ(a) were 3 nm and 54 nm, respectively. The surface roughness of the film was 6.1 nm.

The smoothness Ra of each of AF-31 through AF-34 prepared by the heat shrinking method is 4 nm or more. Such the smoothness was undesirable for the optical film from the view point of the uniformity of image.

In contrast, the smoothness Ra of the optical film according to the present invention was small as shown in Table 1 since the film was stretched in a stretching ratio of not less than 1.0; therefore these films were excellent in the uniformity for the optical film.

(Preparation of Optical Film B Preferable in the Present Invention).

(Preparation of Polymer)

Firstly, Polymer 7 was prepared for preparation of Optical Film B preferable in the present invention.

The polymer was synthesized by bulk polymerization according to the method described in JP-A No. 2000-344823. Methyl methacrylate and ruthenocen described below were introduced into a flask having a stirrer, a nitrogen gas introducing pipe, a thermometer, a mouth for charging the materials and a reflux condenser while heating the content at 70° C. After that, the half amount of β-mercaptopropionic acid sufficiently exchanged by nitrogen gas described below was added into the flask while stirring. The content of the flask was polymerized for 2 hours while the temperature was kept at 70° C. Moreover, the remaining β-mercaptopropionic acid exchanged by nitrogen gas was additionally added and then the content was polymerized by keeping the temperature at 70° C. for 4 hours while stirring. After that, the temperature of the reacting substance was decreased to room temperature and 200 parts by weight of tetrahydrofuran solution containing 5% by weight of benzoquinone was added to stop the polymerization reaction. The product was gradually heated to 80° C. under reduced pressure in an evaporator to remove tetrahydrofuran, remaining monomer and remaining thiol compound to obtain Polymer 7. The weight average molecular weight of the polymer was 3,400 and the hydroxyl value of the polymer measured by the following method. was 50 mgKOH/g.

| | | |
|---|---|---|
| Methyl methacrylate | 100 | parts by weight |
| Ruthenocen (metal catalyst) | 0.05 | part by weight |
| β-mercaptopropionic acid | 12 | parts by weight |

(Method for Measuring Hydroxyl Value)

The method was defined by JIS K 0070 (1992). The hydroxyl value is defined by the number of milligrams of potassium hydroxide necessary for neutralizing acetic acid bonded with the hydroxyl group. In concrete, ×g (about 1 g) of the sample was exactly weighed and put into a flask and 20 ml of acetylation reagent (in which 20 ml of acetic anhydride was mixed with pyridine so that the total volume was 400 ml), was exactly added. An air cooling pipe was attached to the flask and heated in a glycerol bath held at a temperature of 95 to 100° C. After 90 minutes, the flask was cooled and 1 ml of purified water was added through the air cooler tube to decompose acetic anhydride to acetic acid. Then the content of the flask was titrated by a 0.5 mole/liter potassium hydroxide methanol solution by using a potentiometric titration apparatus. The flexion point on the resultant titration curve was defined as the end point. Furthermore, the system without sample is titrated to obtain the flexion point of the titration curve as the blank test. The hydroxyl value was calculated by the following equation.
Hydroxyl value={(B−C)×f×28.05/X}+D

In the above Equation, B is the amount in ml of the 0.5 moles/L potassium hydroxide methanol solution used for the blank test, C is the amount in ml of the 0.5 moles/L potassium hydroxide methanol solution used for the titration, f is the factor of the 0.5 moles/L potassium hydroxide methanol solution, and D is acid value and 28.05 is a half value of the molar weight of potassium hydroxide of 56.11.

(Preparation of Optical Film BF-1 Preferable in the Present Invention)

(Silicon Dioxide Dispersion A)

Aerogil 972V having an average diameter of primary particles of 16 nm, and an apparent specific gravity of
90 g/liter (Nihon Aerogil Co., Ltd.)

12 parts by weight

| | | |
|---|---|---|
| Ethanol | 88 | parts by weight |

The above composition was stirred for 30 minutes using a dissolver and then dispersed by using Manton-Gaulin homogenizer. The turbidity of the resultant dispersion was 200 ppm. To the silicon dioxide dispersion, 88 parts by weight of methylene chloride was added while stirring to prepare diluted silicon dioxide dispersion A.

(Preparation of In-Line Adding Liquid A)

| | | |
|---|---|---|
| Tinubin 109 (Ciba Specialty Chemicals) | 11 | parts by weight |
| Tinubin 171 (Ciba Specialty Chemicals) | 5 | parts by weight |
| Methylene chloride | 100 | parts by weight |

The above composition was charged into a closed vessel, heated while stirring in order to completely dissolve the composition, and then filtered.

To the resultant solution, 36 parts by weight of the diluted silicone dioxide dispersion A was added while stirring and then further stirred for 30 minutes. After that, 6 parts by weight of cellulose acetate propionate having an acetyl substitution degree of 1.9 and a propionyl substitution degree of 0.8 was added while stirring, and further stirred for 60 minutes, followed by filtering through a polypropylene wound cartridge filter TCW-PPS-1N, manufactured by Advantic Toyo Co., Ltd., to prepare an in-line adding liquid A.

(Preparation of Dope A)

| | | |
|---|---|---|
| Cellulose ester CE-4 | 100 | parts by weight |
| Polymer 7 prepared as above | 12 | parts by weight |
| Methylene chloride | 440 | parts by weight |
| Ethanol | 40 | parts by weight |

The above composition was charged into a closed vessel, heated while stirring to completely dissolve the composition, followed by filtering with Azumi Filter Paper No. 24, manufactured by Azumi Filter Paper Co., Ltd., to prepare a Dope A.

Dope A was filtered in the film forming line through Finemet NF and in-line adding liquid A was also filtered through Finemet NF, manufactured by Nihon Seisen Co., Ltd., in the course of an in-line adding line. To 100 parts by weight of filtered Dope A, 2 parts by weight of filtered in-line adding liquid A was added and sufficiently mixed by an in-line mixer (Toray static in-line mixer Hi-Mixer SWJ), and then uniformly cast onto a stainless steel belt support having a width of 1.8 m at 35° C. using a belt casting machine. The solvent was evaporated on the stainless steel belt support until the residual solvent decreased to 120% and the web was peeled off from the stainless steel belt support. The solvent was evaporated at 35° C. from the peeled cellulose ester web and the web was slit in to 1.65 m width and then dried at 150° C. while stretching in the ratio of 1.1 times by the tenters in TD direction (direction orthogonal to the transportation direction). The residual solvent amount was 30% when the stretching by tenter was started.

After that, the drying was completed by transporting the web through many rollers in a drying zone kept at 110 to 120° C. The dried film was slit into 1.5 m width, and knurling having a width of 15 mm and an average height of 10 μm was provided at both edges of the film. The film was wound on a core having an internal diameter of 6 inches by an initial winding tension of 220 N/m and a final winding tension of 110 N/m. Thus Optical Film BF-1 having a thickness of 80 μm preferable in the present invention was obtained.

The retardation values of Rₒ(b) and Rₜₕ(b) of Optical Film BF-1 were 0.1 nm and 0 nm, respectively.

(Preparation of Optical Film BF-2 Preferable in the Present Invention)

Optical Film BF-2 was prepared in the same manner as in Optical Film BF-1 except that the adding amount of Polymer 7 was varied to 20 parts by weight. The retardation values of Rₒ(b) and Rₜₕ (b) of Optical Film BF-2 were 0.2 nm and −10 nm, respectively.

(Preparation of Optical Film BF-3)

Optical Film BF-3 was prepared in the same manner as Optical Film BF-1 preferable in the present invention except that Polymer 7 was replaced with trimethylolpropane tribenzoate and the drying temperature after the stretching was changed to 135° C. The retardation values of Rₒ(b) and Rₜₕ of Optical Film BF-3 were 0.2 nm and 50 nm, respectively.

(Preparation of Optical Film BF-4)

Optical Film BF-4 was prepared in the same manner as Optical Film BF-1 except that Polymer 7 was replaced with trimethylolpropane tribenzoate, the drying temperature after the stretching was changed to 135° C. and the thickness of the film was changed to 40 μm. The retardation values of Rₒ(b) and Rₜₕ(b) of Optical Film BF-4 were 0.1 nm and 29 nm, respectively.

(Preparation of Polarizing Plate)

Polyvinyl alcohol film having a thickness of 50 μm was uniaxially stretched in a ratio of 5 times at 110° C. The stretched film was immersed for 60 seconds in an aqueous solution containing 6 g of potassium iodide, 0.075 g of iodine, 7.5 g of boric acid and 100 g of water, and then immersed in an aqueous solution containing 6 g of potassium iodide, 7.5 g of boric acid and 100 g of water at 68° C. After that the film was washed and dried to obtain a polarizing element.

According to the following Processes 1 to 5, a viewer side polarizing plate and a backlight side polarizing plate were prepared using Optical Films A (Optical Films A1 to A14), Optical Films BF-1 and BF-2 which are preferable in the present invention, and Optical Film BF-3, so that the construction shown as Structure 1 in FIG. 3 was obtained.

Process 1:

Each of the following films was immersed in a 2 moles/liter sodium hydroxide solution kept at 60° C. for 90 seconds, followed by washing with water and drying, to obtain Optical Films A (Optical Films A1 through 14), Optical Films BF-1 and BF-2 which are preferable in the present invention and Optical Films BF-3 and BF-4, each of which had a saponified surface which was to be pasted to a polarizing element.

Process 2:

The polarizing element was immersed in a tank containing a polyvinyl alcohol adhesive solution having a solid content of 2% by weight for 1 to 20 seconds.

Process 3:

The excessive adhesive solution on the polarizing element was lightly swept and the element was piled on each of the optical films mentioned in Process 1.

Process 4:

The optical film and the polarizing element piled in Process 3 were pasted applying a pressure of 20 to 30 N/cm² and in a transporting rate of approximately 2 m/minute.

Process 5:

The sample formed by pasting the optical film and the polarizing element prepared in Process 4 was dried for 2 minutes at 80° C. to prepare a polarizing plate.

A backlight side polarizing plate having a constitution of Structure 2 shown in FIG. 3 was prepared by using comparative Optical Films AF-31 to AF-34 prepared by a thermal shrinking method, which were to be pasted to a polarizing element through an adhesive layer.

(Test for Durability of Polarizing Plate in a High Temperature—High Humidity Condition)

The polarizing plate to be used on the backlight side of the liquid crystal display was cut into two pieces. These two pieces were respectively pasted on both sides of a glass plate so that the polarization axes of them crossed orthogonal to each other. Thus prepared sample was stood for 500 hours in an environment of 60° C. and 90% RH.

The transmittance of the sample was measured before and after the durability test by a spectral photometer U-3400, manufactured by Hitachi Seisakusho Co., Ltd. The difference between the transmittance before and after the durability test was evaluated. The transmittance was not more than 0.1% and the variation in the transmittance was less than 0.05% in all polarizing plates of the present invention. The transmittance of the polarizing plates using AF-31, AF-32, AF-33 and AF-34 were 0.15%, 0.2%, 1.1% and 1.3%, respectively. The variations in the transmittance caused by the test of AF-31, AF-32, AF-33 and AF-34 were each 0.11%, 0.14%, 1.0% and 1.2%, respectively. The polarizing plates of the present invention were superior on the point that the variation in the transmittance of the plates in the state of crossed for making a right angel was small since the optical film superior in the keeping property was used.

(Preparation of Liquid Crystal Display)

Liquid crystal panels for evaluating the visibility were prepared as follows and the properties of them as the liquid crystal display were evaluated.

Polarizing plates pasted on both surfaces of liquid crystal cell of an IPS mode liquid crystal display of Hitachi liquid crystal TV Wooo W17-LC50 were peeled and each of the above-prepared polarizing plates was pasted onto the glass surface of the liquid crystal cell.

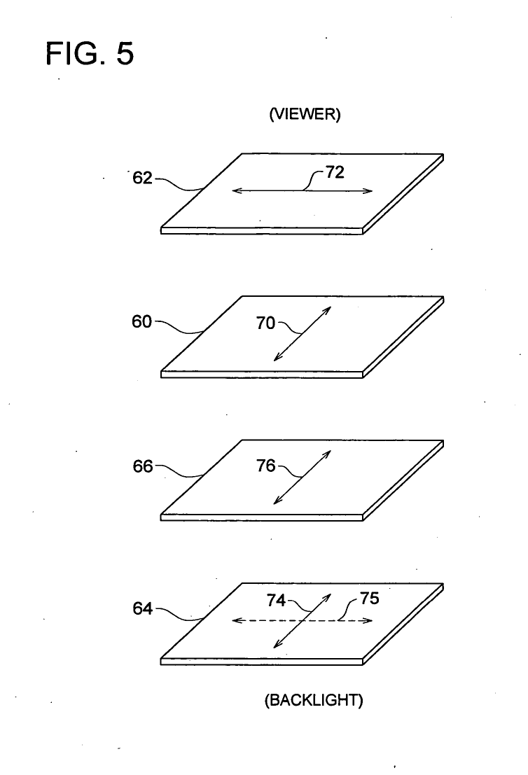

The pasting direction of the polarizing plate and the constitution of the liquid crystal display were those shown in Table 3 and FIG. 3., and the slow axis of Optical Film A or the comparative optical film was arranged so as to be parallel (see FIG. 4) or orthogonal (see FIG. 5). Thus liquid crystal displays 101 through 119 were prepared.

(Evaluation of Viewing Angle)

The viewing angle of each of the liquid crystal displays was measured by EZ-Contrast, manufactured by ELDIM Co., Ltd., for evaluating the viewing angle. In the evaluation, the contrast between white image and black image (a ratio of: (intensity of light emitted from a white image)/(intensity of light emitted from and a black image)) displayed on the liquid crystal panel viewed from the angle of 80° with the normal line of the panel surface was measured from all directions and the measured result was ranked according to the following criteria.
A: The contrast was not less than 40 in all direction.
B: The contrast was not less than 30 in all direction.
C: The contrast was not less than 20 in all direction.
D: The contrast was not less than 10 in all direction.
E: There was a region in which the contrast in all direction of not less than 5 and less than 15.
F: There was a region in which the contrast in all direction of less than 5.

The constitution of the liquid crystal displays and the evaluation results are shown in the following Table 2.

TABLE 2

| Liquid | Viewer side | | | | | | | |
|---|---|---|---|---|---|---|---|---|
| crystal | polarizing plate | | Backlight side polarizing plate | | | | Viewing | |
| display | Optical film No. | | Optical film No. | | | | angle | |
| No. | 1a | 2a | 2C | 2b | 1b | *1 | property | remarks |
| 101 | BF-3 | BF-1 | — | Optical Film A-1 | BF-3 | | B | Inventive |
| 102 | BF-3 | BF-2 | — | Optical Film A-2 | BF-3 | | B | Inventive |
| 103 | BF-3 | BF-2 | — | Optical Film A-3 | BF-3 | | C | Inventive |
| 104 | BF-3 | BF-1 | — | Optical Film A-4 | BF-3 | | B | Inventive |
| 105 | BF-3 | BF-1 | — | Optical Film A-5 | BF-3 | | A | Inventive |
| 106 | BF-3 | BF-1 | — | Optical Film A-6 | BF-3 | | C | Inventive |
| 107 | BF-3 | BF-1 | — | Optical Film A-7 | BF-3 | | C | Inventive |
| 108 | BF-3 | BF-2 | — | Optical Film A-8 | BF-3 | | B | Inventive |
| 109 | BF-3 | BF-1 | — | Optical Film A-9 | BF-3 | | C | Inventive |
| 110 | BF-3 | BF-1 | — | Optical Film A-10 | BF-3 | | C | Inventive |
| 111 | BF-3 | BF-2 | — | Optical Film A-11 | BF-3 | | C | Inventive |
| 112 | BF-3 | BF-1 | — | Optical Film A-12 | BF-3 | | B | Inventive |
| 113 | BF-3 | BF-1 | — | Optical Film A-13 | BF-3 | | C | Inventive |
| 114 | BF-3 | BF-1 | — | Optical Film A-14 | BF-3 | | F | Comparative |
| 115 | BF-3 | BF-3 | — | BF-3 | BF-3 | | F | Comparative |
| 116 | BF-3 | BF-3 | AF-31 | BF-3 | BF-3 | | E | Comparative |
| 117 | BF-3 | BF-3 | AF-32 | BF-3 | BF-3 | | E | Comparative |
| 118 | BF-3 | BF-3 | AF-33 | BF-3 | BF-3 | | F | Comparative |
| 119 | BF-3 | BF-3 | AF-34 | BF-3 | BF-3 | | F | Comparative |

*1: Relation between the direction of slow axis of optical film and the direction of absorbing axis of polarizing element

It is understood that the liquid crystal displays 101 to 113 according to the present invention are considerably superior to the comparative liquid crystal displays 114 to 119. Among them, ones each having a Rₜₕ(a) of −30 nm to +20 nm, which is preferable range of the present invention, show large improving effect on the viewing angle property.

### Example 2

Polarizing plates and liquid crystal displays 120 to 133 were prepared in the same manner as in Example 1 except that Optical Films BF-1 and BF-2 using Optical Film 2a were replaced with Optical Film BF-3, and the viewing angle of the displays was evaluated in the same manner as in Example 1.

The results of the evaluation are listed in Table 3.

TABLE 3

| Liquid | Viewer side | | | | | | | |
|---|---|---|---|---|---|---|---|---|
| crystal | polarizing plate | | Backlight side polarizing plate | | | | Viewing | |
| display | Optical film No. | | Optical film No. | | | | angle | |
| No. | 1a | 2a | 2C | 2b | 1b | *1 | property | remarks |
| 120 | BF-3 | BF-3 | — | Optical Film A-1 | BF-3 | | C | Inventive |
| 121 | BF-3 | BF-3 | — | Optical Film A-2 | BF-3 | | C | Inventive |
| 122 | BF-3 | BF-3 | — | Optical Film A-3 | BF-3 | | D | Inventive |
| 123 | BF-3 | BF-3 | — | Optical Film A-4 | BF-3 | | C | Inventive |
| 124 | BF-3 | BF-3 | — | Optical Film A-5 | BF-3 | | C | Inventive |
| 125 | BF-3 | BF-3 | — | Optical Film A-6 | BF-3 | | D | Inventive |
| 126 | BF-3 | BF-3 | — | Optical Film A-7 | BF-3 | | D | Inventive |
| 127 | BF-3 | BF-3 | — | Optical Film A-8 | BF-3 | | D | Inventive |
| 128 | BF-3 | BF-3 | — | Optical Film A-9 | BF-3 | | C | Inventive |
| 129 | BF-3 | BF-3 | — | Optical Film A-10 | BF-3 | | D | Inventive |
| 130 | BF-3 | BF-3 | — | Optical Film A-11 | BF-3 | | D | Inventive |
| 131 | BF-3 | BF-3 | — | Optical Film A-12 | BF-3 | | C | Inventive |
| 132 | BF-3 | BF-3 | — | Optical Film A-13 | BF-3 | | D | Inventive |
| 133 | BF-3 | BF-3 | — | Optical Film A-14 | BF-3 | | F | Comparative |

*1: Relation between the direction of slow axis of optical film and the direction of absorbing axis of polarizing element

The liquid crystal displays 120 to 132 were superior in the viewing angle property; however, the improvement effect was slightly smaller compared with the liquid crystal displays prepared in Example 1. Liquid crystal display 133 using comparative Optical Film A14 was inferior in the viewing angle; the result in Example 1 was reproduced.

### Example 3

A crystal display was prepared in the same manner as in Example 1 except that Optical Film BF-3 was replaced with Optical Film BF-4, and the viewing angle of the displays was evaluated in the same manner as in Example 1. Result of Example 1 was reproduced.

A crystal display was prepared in the same manner as in Example 2 except that Optical Film BF-3 was replaced by Optical Film BF-4, FFS mode liquid crystal display of Hitachi liquid crystal TV Wooo W32-L7000. Result of Example 2 was reproduced.

### Example 4

Liquid crystal displays were prepared in the same manner as in Example 1 except that the FFS mode liquid crystal display of Hitachi liquid crystal TV Wooo W32-L7000 was used in place of IPS mode liquid crystal display of Hitachi liquid crystal TV Wooo W17-LC50, and the viewing angle of each of the displays was evaluated. The results of Example 1 were reproduced and the liquid crystal displays according to the present invention were superior in the viewing angle property.

What is claimed is:

1. An optical film comprising a resin and birefringent needle-shaped particles, the resin being added with the birefringent needle-shaped particles and being stretched to form the optical film (hereafter designated as Optical Film A), wherein
(i) the resin exhibits a positive birefringence along a stretching direction when stretched;
(ii) the birefringent needle-shaped particle exhibits a negative birefringence along the stretching direction of the optical film; and
(iii) the optical film satisfies the following relationships:
ny(a)<nz(a)<nx(a)
105 nm≦Ro(a)≦350 nm
0.2<Nz<0.7
wherein Ro(a) and Nz are defined as follows:
Ro(a)=(nx(a)−ny(a))×d Equation (i)
Nz=(nx(a)−nz(a))/(nx(a)−ny(a)) Equation (ii)
wherein y represents the stretching direction of the resin film, ny(a) represents an in-plane refractive index of the optical film along the stretching direction, nx(a) represents an in-plane refractive index of the optical film along a direction orthogonal to the stretching direction, nz(a) represents an refractive index of the optical film along a thickness direction of the optical film, and d represents a thickness (nm) of the optical film.

2. The optical film of claim 1, wherein a retardation value Rth(a) defined by Equation (iii) is in the range of −30 nm≦Rth(a)≦+20 nm:
Rth(a)={(nx(a)+ny(a))/2−nz(a)}×d. Equation (iii)

3. The optical film of claim 1, wherein the resin comprises a cellulose ester.

4. A polarizing plate comprising the optical film of claim 1, wherein a slow axis of the optical film is set substantially parallel to or substantially orthogonal to an absorption axis of a polarizing element of the polarizing plate.

5. An in-plane switching mode liquid crystal display, wherein at least one of polarizing plates provided on both surfaces of an in-plane switching mode liquid crystal cell is the polarizing plate of claim 4.

6. An in-plane switching mode liquid crystal display comprising:
an in-plane switching mode liquid crystal cell; and
two polarizing plates provided on both surfaces of the liquid crystal cell, each polarizing plate comprising a polarizing element and a polarizing plate protective film sandwiched between the polarizing element and the liquid crystal cell,
wherein one of the polarizing plate protective films (hereafter designated as Optical Film A) is a stretched resin film and satisfies the following relatioships:
ny(a)<nz(a)<nx(a)
105 nm≦Ro(a)≦350 nm
0.2<Nz<0.7
wherein Ro(a) and Nz are defined as follows:
Ro(a)=(nx(a)−ny(a))×d Equation (iv)
Nz=(nx(a)−nz(a))/(nx(a)−ny(a)) Equation (v)
wherein y represents a stretching direction of the resin film, ny(a) represents an in-plane refractive index of the optical film along the stretching direction, nx(a) represents an in-plane refractive index of the optical film along a direction orthogonal to the stretching direction, nz(a) represents an refractive index of the optical film along a thickness direction of the optical film, and d represents a thickness (nm) of the optical film.

7. The in-plane switching mode liquid crystal display of claim 6, wherein Optical Film A is a stretched resin film containing birefringent needle-shaped particles, wherein
(i) a resin contained in Optical Film A exhibits a positive birefringence along a stretching direction when stretched;
(ii) the birefringent needle-shaped particle exhibits a negative birefringence along the stretching direction of the resin film.

8. The in-plane switching mode liquid crystal display of claim 6, wherein the polarizing plate protective film other than Optical Film A (hereafter designated as Optical Film B) satisfies the following relationships:
−15 nm≦Ro(b)≦15 nm
−15 nm≦Rth(b)≦15 nm
wherein Ro(a) and Rth(b) are defined as follows:
Ro(b)=(nx(b)−ny(b))×d Equation (vi)
Rth(b)={(nx(b)+ny(b))/2−nz(b)}×d
wherein ny(b) represents an in-plane refractive index of Optical Film B along the stretching direction, nx(b) represents an in-plane refractive index of the optical film along a direction orthogonal to the stretching direction, nz(b) represents an refractive index of the optical film along a thickness direction of the optical film, and d represents a thickness (nm) of the optical film.
